(19) United States
(12) Patent Application Publication
(10) Pub. No.: US 2013/0078297 A1
(43) Pub. Date: Mar. 28, 2013

(54) Aqueous Active Ingredient Composition

(71) Applicants: Ulf Schlotterbeck, Mannheim (DE); Katharine Klamczynski, Boehl-Iggelheim (DE); Uwe Hartnagel, Lorsch (DE)

(72) Inventors: Ulf Schlotterbeck, Mannheim (DE); Katharine Klamczynski, Boehl-Iggelheim (DE); Uwe Hartnagel, Lorsch (DE)

(73) Assignee: BASF SE, Ludwigshafen (DE)

(21) Appl. No.: 13/703,231

(22) PCT Filed: Jun. 15, 2011
(86) PCT No.: PCT/EP2011/059874

§ 371 Date: Dec. 10, 2012

Related U.S. Application Data
(60) Provisional application No. 61/355,183, filed on Jun. 16, 2010.

(30) Foreign Application Priority Data
Jun. 16, 2010 (EP) 10166192.4

(51) Int. Cl. A01N 25/04

(52) U.S. Cl. CPC A01N 25/04
USPC 424/405; 514/383; 514/407

(57) ABSTRACT

The invention relates to aqueous active ingredient compositions in which the active ingredient or ingredients are present in the form of an aqueous dispersion of finely divided polymer-active ingredient particles which comprise at least one water-insoluble polymer P, at least one surface-active substance, and at least one organic active crop protection ingredient which is present in the polymer particles and has a solubility in water of not more than 5 g/l at 25° C./101.325 hPa, in which the polymer-active ingredient particles have an average particle diameter, determined by dynamic light scattering, in the range from 300 to 1200 nm, preferably in the range from 310 to 1000 nm, and more particularly in the range from 320 to 800 nm, the polymer P being a polymer of ethylenically unsaturated monomers M which comprise 0.1% to 10%, more particularly 0.2% to 7%, and especially 0.3% to 5%, by weight, based on the total amount of the constituent monomers M of the polymer P, of at least one monoethylenically unsaturated compound M2 which is selected from monoethylenically unsaturated sulfonic acids, monoethylenically unsaturated phosphonic acids, and monoethylenically unsaturated phosphoric monoesters, and also the salts thereof, the amounts in % by weight being based on the acid form of the monomer M2.

The invention also relates to a process for preparing them and to the use of active ingredient compositions of this kind.

The invention relates to an aqueous active ingredient composition in the form of an aqueous dispersion of finely divided polymer-active ingredient particles which comprise at least one water-insoluble polymer P, at least one surface-active substance, and at least one organic active crop protection ingredient present in the polymer particles. The invention also relates to a process for preparing them and to the use of active ingredient compositions of this kind.

Active ingredients for crop protection that are insoluble or of only limited solubility in water, i.e., which have a water solubility of in general not more than 5 g/l at 25° C. and 101.325 hPa, are frequently formulated as aqueous suspension concentrates. Suspension concentrates are aqueous formulations which comprise the active ingredient or ingredients in the form of particles which are in suspension in an aqueous phase. Formulations of this kind have the advantage that they can be diluted easily with water to the desired application concentration and, moreover, include only small amounts of volatile organic constituents. The formulation of active crop protection ingredients (ACPIs) as aqueous suspension concentrates, however, remains confined, of course, to those ACPIs which as well as a sufficiently low water solubility have a sufficiently high melting point, since preparing the suspension concentrates requires the ACPI to be ground to the desired particle size. Moreover, the suspension concentrate formulation frequently entails reduced activity on the part of the ACPI, since the active ingredient particles, owing to their particle size, which is typically in the range of several micrometers, in conjunction with their low water solubility, exhibit a reduced bioavailability.

There have been a number of descriptions of aqueous active ingredient compositions in which the active ingredient is present in the form of polymer-active ingredient particles. Active ingredient compositions of this kind are also referred to below as polymer/active ingredient compositions. With polymer/active ingredient compositions a fundamental distinction is required between those compositions in which the active ingredient particles are surrounded by a thin shell of a water-insoluble polymer (microencapsulated active ingredients) and those compositions in which the active ingredient is present in distribution in a particulate polymer matrix. While the former have comparatively large particle diameters, in the micrometer range, and hence frequently ensure only a comparatively low bioavailability of the active ingredient, there are also nanodispersions known in which the active ingredient is imbedded into the polymer matrix of polymer particles. The latter are prepared primarily by a free-radical aqueous emulsion polymerization of monomer/active ingredient emulsions, the particle sizes of the resultant polymer-active ingredient dispersions being typically not more than 300 nm.

U.S. Pat. No. 3,400,093 discloses aqueous, insecticide-containing active ingredient compositions in the form of aqueous polymer dispersions which are prepared by emulsion polymerization of ethylenically unsaturated monomers, the monomers used for the polymerization comprising a water-insoluble active insecticidal ingredient in dissolved form. The insecticide-containing polymer dispersions described therein are used for producing water-based coating materials such as emulsion paints and are intended thus to ensure that the coating is made insecticidal.

EP 1230855 describes aqueous active ingredient compositions with delayed active ingredient release, in which the active ingredient is embedded in microgel particles constructed from a network of interpenetrating polymer chains. The active ingredient compositions are comparatively costly and inconvenient to prepare, since first of all an active ingredient/monomer emulsion is polymerized and subsequently, in the polymer-active ingredient suspension formed as an intermediate, an emulsion polymerization is carried out in accordance with a feed process. The average particle size of the polymer-active ingredient particles in the aqueous active ingredient compositions described therein is well below 250 nm.

WO 2005/102044 describes aqueous active ingredient compositions comprising at least one active organic fungicidal ingredient having a water solubility of not more than 5 g/l at 25° C./1013 mbar, embedded into a finely divided polymer having an average particle size, determined by dynamic light scattering, of less than 300 nm, the polymer being constructed predominantly of ethylenically unsaturated monomers having a water solubility of not more than 30 g/l at 25° C. These active ingredient compositions are suitable for protecting wood from wood-damaging fungi.

WO 2006/094792 discloses aqueous active ingredient compositions similar to the active ingredient compositions described in WO 2005/102044, which comprise at least one active organic insecticidal ingredient having a water solubility of not more than 5 g/l at 25° C./1013 mbar, the polymer-active ingredient particles having a cationic surface charge. These active ingredient compositions are suitable for protecting wood from wood-damaging insects.

WO 2006/015791 describes a process for preparing aqueous active ingredient compositions comprising at least one organic ACPI, e.g., an active insecticidal, fungicidal, acaricidal or herbicidal ingredient, having a water solubility of not more than 5 g/l at 25° C./1013 mbar, by carrying out a multistage emulsion polymerization process in an aqueous suspension of the solid active ingredient particles. In this way, aqueous dispersions are obtained of polymer-active ingredient particles having particle diameters of preferably below 300 nm, in which the particulate active ingredient is enveloped by the emulsion polymer. The process, of course, is confined to organic ACPIs having a high melting point, since the aqueous active ingredient suspension used in the emulsion polymerization is prepared by a grinding process. These active ingredient compositions are proposed for the protection of wood from wood-damaging parasites.

For many applications, such as seed treatment, for example, it is necessary to formulate aqueous polymer/active ingredient compositions of the above-designated kind with other active ingredients and/or other auxiliaries such as adjuvants or thickeners. The applicant's own investigations have now shown that, when the aqueous polymer/active ingredient compositions known from the prior art are incorporated into a form suitable for marketing, there is frequently separation into a polymer/active ingredient phase and an aqueous phase, and/or the shelf life of the polymer/active ingredient composition, particularly at relatively high temperature, or of the formulations prepared from it, is unsatisfactory. These problems occur in particular when the concluded formulations include thickeners, especially those based on anionic polysaccharides.

It is an object of the present invention, therefore, to provide active ingredient compositions of organic ACPIs with low water solubility that do not have the disadvantages of the prior art, or only to a lesser extent. More particularly, the aim was to provide active ingredient compositions of organic ACPIs having a low melting point. It has surprisingly been found that these and further objects are achieved by the aqueous active ingredient compositions defined in more detail below.

The invention therefore relates to aqueous active ingredient compositions in which the active ingredient or ingredients are present in the form of an aqueous dispersion of finely divided polymer-active ingredient particles which comprise at least one water-insoluble polymer P, at least one surface-active substance, and at least one organic active crop protection ingredient which is present in the polymer particles and has a solubility in water of not more than 5 g/l at 25° C./101.325 hPa, in which the polymer- active ingredient particles have an average particle diameter, determined by dynamic light scattering, in the range from 300 to 1200 nm, preferably in the range from 310 to 1000 nm, and more particularly in the range from 320 to 800 nm, the polymer P being a polymer of ethylenically unsaturated monomers M which comprise 0.1% to 10%, more particularly 0.2% to 7%, and especially 0.3% to 5%, by weight, based on the total amount of the constituent monomers M of the polymer P, of at least one monoethylenically unsaturated compound M2 which is selected from monoethylenically unsaturated sulfonic acids, monoethylenically unsaturated phosphonic acids, and monoethylenically unsaturated phosphoric monoesters, and also the salts thereof, the amounts in % by weight being based on the acid form of the monomer M2.

The polymer-active ingredient compositions of the invention feature a high stability and can be converted without problems into a form suitable for application, without separation. The aqueous active ingredient compositions of the invention are suitable in particular for coformulations with conventional aqueous suspension concentrates and/or for formulation with thickeners, especially with thickeners selected from anionic polysaccharides.

In the aqueous active ingredient compositions of the invention, the at least one organic ACPI is present substantially in the form of polymer-active ingredient particles which are in dispersion in a coherent phase. Without being tied to a theory, it is assumed that this at least one ACPI is present to an extent of at least 90% by weight, based on the total amount of this ACPI, in distribution in the polymer particles. The distribution of the active ingredient within the polymer particles may be homogeneous or inhomogeneous, the ACPI presumably being present predominantly in a molecularly disperse distribution, i.e., as a solution of the ACPI in the polymer P.

Within the polymer particles, the distribution of the active ingredient may be uniform. The polymer particles may alternatively have regions with different concentrations of active ingredient. In this case, the regions of high active ingredient concentration and the regions of low active ingredient concentration may have a core-shell arrangement (core-shell morphology), or may be present in the form droplet-shaped or spherical regions (half-moon morphology), which are partially interpenetrating or which, optionally, are embedded into a matrix or arranged on a polymer matrix (blackberry or raspberry morphology).

In one embodiment of the invention the polymer particles have regions with a high active ingredient concentration and regions with a low active ingredient concentration, the former being arranged in the outer regions and the latter in the inner regions of the polymer particles. For example, the regions of higher concentration form a continuous or perforated shell around a core with a lower active ingredient concentration, or the regions of higher concentration form droplets or spheres whose major amount is arranged on a core region with lower concentration or is embedded, at the surface of this core region, into said region.

In addition, the aqueous active ingredient compositions of the invention may also comprise one or more other ACPIs which are different from the ACPI present in the polymer-active ingredient particles and which are not present in the polymer particles.

The polymer-active ingredient particles comprise the at least one water-insoluble polymer P, composed of polymerized ethylenically unsaturated monomers M, and the organic ACPI. The water-insoluble polymer P and the at least one ACPI typically account for at least 95%, and more particularly at least 98%, by weight of the polymer-active ingredient particles. In the case of an aqueous composition of the invention which alongside the organic ACPI present in the polymer-active ingredient particles comprises no further constituents of low water solubility, examples being ACPIs with low water solubility, the water-insoluble polymer P and the at least one ACPI account for at least 95%, more particularly at least 98%, by weight of the water-insoluble constituents of the active ingredient composition of the invention.

In general the at least one organic ACPI accounts for 1% to 50%, more particularly 10% to 40%, by weight of the total weight of the polymer-active ingredient particles in the aqueous active ingredient composition. The fraction of the water-insoluble polymer P, based on the total weight of the polymer-active ingredient particles, is in general 50% to 99%, and more particularly 60% to 90%, by weight.

The aqueous active ingredient compositions of the invention comprise the active ingredient in the form of polymer-active ingredient particles which are in dispersion in an aqueous phase. The polymer-active ingredient particles have, in accordance with the invention, an average particle diameter (weight average), determined by dynamic light scattering, in the range from 300 to 1200 nm, preferably in the range from 310 to 1000 nm, and more particularly in the range from 320 to 800 nm. In this context it has proven advantageous if the fraction of the polymer-active ingredient particles which have a particle diameter of up to 200 nm (D₁₀ of the particle size distribution) is less than 10% by weight, based on the total amount of the polymer-active ingredient particles in the active ingredient composition.

The particle sizes/particle diameters or particle radii indicated here for the polymer-active ingredient particles are particle diameters as may be determined by means of photon correlation spectroscopy (PCS), also known as quasi-elastic light scattering (QELS) or dynamic light scattering. The average particle diameters constitute the average value of the cumulant analysis (mean of fits). This “mean of fits” is an average, intensity-weighted particle diameter in nm, which corresponds to the weight-average particle diameter. The measurement method is described in the ISO 13321 standard. Processes for this purpose are familiar to the skilled worker, moreover, from the relevant technical literature—for example, from H. Wiese in D. Distler, Wässrige Polymerdispersionen, Wiley-VCH 1999, section 4.2.1, p. 40ff and literature cited therein, and also H. Auweter, D. Horn, J. Colloid Interf. Sci. 105 (1985) 399, D. Lilge, D. Horn, Colloid Polym. Sci. 269 (1991) 704 or H. Wiese, D. Horn, J. Chem. Phys. 94 (1991) 6429. The particle diameters indicated here relate to the values determined at 20° C. and 101.325 hPa on 0.001-1% by weight dispersions. The determination of the average particle diameters may also be performed by means of hydrodynamic chromatography (HDC) using a Particle Size Distribution Analyser (PSDA, Varian Deutschland GmbH) with a number 2 (standard) cartridge at a wavelength of 254 nm (measurement temperature 23° C. and measurement time 480 seconds).

The polymer-active ingredient particles present in the active ingredient compositions of the invention comprise at least one water-insoluble polymer which is constructed of polymerized, ethylenically unsaturated monomers M. By water-insoluble in relation to the polymer P is meant that under atmospheric pressure (101.325 hPa) and at temperatures in the range from 0 to 100° C. the polymer P is not dissolved without decomposition in water.

A low solubility of this kind is ensured, in a known way, by the constituent monomers M of the polymer P, which accordingly are used for preparing the polymers P, comprising predominantly, in general at least 70% by weight, frequently at least 80% by weight, more particularly at least 90% by weight, based on the total amount of the monomers M, one or more nonionic, neutral monoethylenically unsaturated monomers M′ whose water solubility does not exceed a figure of 50 g/l, more particularly 30 g/l, at 25° C. and 101.325 hPa and a pH of 7, it being possible for part of these monomers M′, but preferably not more than 50% by weight, more particularly not more than 30% by weight, based on the total amount of the monomers M′, to be replaced by acrylonitrile or methacrylonitrile, which taken per se have a higher water solubility.

The constituent monomers M of the polymer P, accordingly, comprise in general:
70% to 99.9%, frequently 80% to 99.8% or 80% to 99.7%, and more particularly 90% to 99.7% or 90% to 99.5%, by weight, of at least one neutral monoethylenically unsaturated monomer M′ whose water solubility does not exceed a level of 50 g/I, more particularly 30 g/l, at 25° C. and 101.325 hPa, or a mixture of one or more of these monomers M′ with acrylonitrile or methacrylonitrile;
0.1% to 10%, frequently 0.2% to 7%, and more particularly 0.3% to 5%, by weight, of at least one monoethylenically unsaturated monomer M2 selected from monoethylenically unsaturated sulfonic acids, monoethylenically unsaturated phosphonic acids, and monoethylenically unsaturated phosphoric monoesters, and also the salts thereof, the figures in % by weight being based on the free acid; and optionally
0% to 29.9%, frequently 0% to 19.8% or 0.1% to 19.8%, and more particularly 0% to 9.7% or 0.2% to 9.7%, by weight, of one or more monomers M3, which are different from the monomers M′ and M2;
   where all figures in % by weight are based on the total weight of the constituent monomers M of the polymer.

The term “monoethylenically unsaturated” used here and below means that the respective monomer has one polymerizable C═C double bond, more particularly one C═C double bond polymerizable under the conditions of a free-radical aqueous emulsion polymerization.

The prefixes Cₙ-Cₘ used here and below specify a range for the possible number of carbon atoms in each case that may be present in a radical thus identified or a compound designated therewith.

Thus, for example, C₁-C₂₀ alkyl, or C₁-C₁₀ alkyl or C₁-C₄ alkyl, stands for a linear or branched saturated alkyl radical having 1 to 20, or 1 to 10 or 1 to 4, C atoms.

Thus, for example, C₅-C₈ alkanol stands for a monovalent cycloaliphatic alcohol having 5 to 8 C atoms such as, for example, cyclopentanol, cyclohexanol, cycloheptanol, methylcyclohexanol or cyclooctanol.

Thus, for example, phenyl-C₁-C₄ alkanol or phenoxy-C₁-C₄ alkanol stand for a phenyl- or phenoxy-substituted monovalent alkanol, respectively, the alkanol moiety having 1 to 4 C atoms. Examples of phenyl-C₁-C₄ alkanol are benzyl alcohol, 1-phenylethanol and 2-phenylethanol. An example of phenoxy-C₁-C₄ alkanol is 2-phenoxyethanol.

Monoethylenically unsaturated C₃-C₆ monocarboxylic acids stands for a monoethylenically unsaturated monocarboxylic acid having 3 to 6 C atoms, such as acrylic acid, methacrylic acid, vinylacetic acid or crotonic acid, for example.

Monoethylenically unsaturated C₄-C₆ dicarboxylic acids stands for a monoethylenically unsaturated dicarboxylic acid having 4 to 6 C atoms, such as maleic, fumaric, itaconic or citraconic acid, for example.

Examples of suitable monoethylenically unsaturated monomers M′ are:
esters of monoethylenically unsaturated C₃-C₆ monocarboxylic acids with C₁-C₂₀ alkanols, C₅-C₈ cycloalkanols, phenyl-C₁-C₄ alkanols or phenoxy-C₁-C₄ alkanols, more particularly the aforementioned esters of acrylic acid and also the aforementioned esters of methacrylic acid;
diesters of monoethylenically unsaturated C₄-C₆ dicarboxylic acids with C₁-C₂₀ alkanols, C₅-C₈ cycloalkanols, phenyl-C₁-C₄ alkanols or phenoxy-C₁-C₄ alkanols, more particularly the aforementioned esters of maleic acid;
vinylaromatic hydrocarbons, such as, for example, styrene, vinyltoluenes, tert-butylstyrene, α-methylstyrene, and the like, more particularly styrene;
vinyl, allyl, and methallyl esters of saturated aliphatic C₂-C₁₈ monocarboxylic acids; and
α-olefins having 2 to 20 C atoms, and also conjugated diolefins such as butadiene and isoprene.

Examples of esters of monoethylenically unsaturated C₃-C₆ monocarboxylic acids with C₁-C₂₀ alkanols, C₅-C₈ cycloalkanols, phenyl-C₁-C₄ alkanols or phenoxy-C₁-C₄ alkanols are, in particular, the esters of acrylic acid such as methyl acrylate, ethyl acrylate, n-propyl acrylate, isopropyl acrylate, n-butyl acrylate, 2-butyl acrylate, isobutyl acrylate, tert-butyl acrylate, n-hexyl acrylate, 2-ethylhexyl acrylate, 3-propylheptyl acrylate, decyl acrylate, lauryl acrylate, stearyl acrylate, cyclohexyl acrylate, benzyl acrylate, 2-phenylethyl acrylate, 1-phenylethyl acrylate, 2-phenoxyethyl acrylate, and also the esters of methacrylic acid such as methyl methacrylate, ethyl methacrylate, n-propyl methacrylate, isopropyl methacrylate, n-butyl methacrylate, 2-butyl methacrylate, isobutyl methacrylate, tert-butyl methacrylate, n-hexyl methacrylate, 2-ethylhexyl methacrylate, decyl methacrylate, lauryl methacrylate, stearyl methacrylate, cyclohexyl methacrylate, benzyl methacrylate, 2-phenylethyl methacrylate, 1-phenylethyl methacrylate, and 2-phenoxyethyl methacrylate.

Examples of diesters of monoethylenically unsaturated C₄-C₆ dicarboxylic acids with C₁-C₂₀ alkanols, C₅-C₈ cycloalkanols, phenyl-C₁-C₄ alkanols or phenoxy-C₁-C₄ alkanols are, in particular, the diesters of maleic acid and the diesters of fumaric acid, more particularly di-C₁-C₂₀ alkyl maleinates and di-C₁-C₂₀ alkyl fumarates such as dimethyl maleinate, diethyl maleinate, di-n-butyl maleinate, dimethyl fumarate, diethyl fumarate, and di-n-butyl fumarate.

Examples of vinyl, allyl, and methallyl esters of saturated aliphatic C₂-C₁₈ monocarboxylic acids are vinyl acetate, vinyl propionate, vinyl butyrate, vinyl pivalate, vinyl hexanoate, vinyl-2-ethylhexanoate, vinyl laurate, and vinyl stearate, and also the corresponding allyl and methallyl esters.

Examples of α-olefins having 2 to 20 C atoms are ethylene, propylene, 1-butene, isobutene, 1-pentene, 1-hexene, diisobutene, and the like.

Among the monomers M′, the esters of monoethylenically unsaturated C₃-C₆ monocarboxylic acids, more particularly the esters of acrylic acid or of methacrylic acid, with C₁-C₂₀ alkanols, C₅-C₈-cycloalkanols, phenyl-C₁-C₄ alkanols or phenoxy-C₁-C₄ alkanols, diesters of monoethylenically unsaturated C₄-C₆ dicarboxylic acids with C₁-C₂₀ alkanols, C₅-C₈ cycloalkanols, phenyl-C₁-C₄ alkanols or phenoxy-C₁-C₄ alkanols, and vinylaromatic hydrocarbons, especially styrene, are preferred.

Among the monomers M′, the esters of monoethylenically unsaturated C₃-C₆ monocarboxylic acids, more particularly the esters of acrylic acid or of methacrylic acid, with C₁-C₂₀ alkanols, and vinylaromatic hydrocarbons, especially styrene, are particularly preferred.

Among the monomers M′, the esters of acrylic acid with C₂-C₁₀ alkanols (═C₂-C₁₀ alkyl acrylates), the esters of methacrylic acid with C₁-C₁₀ alkanols (═C₁-C₁₀ alkyl methacrylates), and vinylaromatic hydrocarbons, especially styrene, are very particularly preferred.

In one particularly preferred embodiment of the invention the monomers M′ are selected from C₁-C₄ alkyl methacrylates, C₂-C₁₀ alkyl acrylates, styrene, mixtures of C₁-C₄-alkyl methacrylates of styrene, mixtures of styrene with C₂-C₁₀ alkyl acrylates, mixtures of C₁-C₄ alkyl methacrylates with C₂-C₁₀ alkyl acrylates, and mixtures of C₁-C₄ alkyl methacrylates with styrene and C₂-C₁₀ alkyl acrylates.

In one very particularly preferred embodiment of the invention the monomers M′ are selected from C₁-C₄ alkyl methacrylates, especially methyl methacrylate, mixtures of methyl methacrylate with styrene, mixtures of C₁-C₄ alkyl methacrylates, especially methyl methacrylate, with C₂-C₁₀ alkyl acrylates, and mixtures of C₁-C₄ alkyl methacrylates, especially methyl methacrylate, with styrene and C₂-C₁₀ alkyl acrylates, with the fraction of C₁-C₄ alkyl methacrylates, especially methyl methacrylate, based on the total amount of the monomers M′, being at least 50% by weight.

Examples of monomers M2 are as follows:
monoethylenically unsaturated sulfonic acids in which the sulfonic acid group is attached to an aliphatic hydrocarbon radical, and salts thereof, such as vinylsulfonic acid, allylsulfonic acid, methallylsulfonic acid, 2-acrylamido-2-methylpropanesulfonic acid, 2-methacrylamido-2-methylpropanesulfonic acid, 2-acrylamidoethanesulfonic acid, 2-methacrylamidoethanesulfonic acid, 2-acryloyloxyethanesulfonic acid, 2-methacryloyloxyethanesulfonic acid, 3-acryloyloxypropanesulfonic acid and 2-methacryloyloxypropanesulfonic acid, and salts thereof,
vinylaromatic sulfonic acids, i.e., monoethylenically unsaturated sulfonic acids in which the sulfonic acid group is attached to an aromatic hydrocarbon radical, more particularly to a phenyl ring, and salts thereof, such as, for example, styrenesulfonic acids such as 2-, 3- or 4-vinylbenzenesulfonic acid and salts thereof,
monoethylenically unsaturated phosphonic acids in which the phosphonic acid group is attached to an aliphatic hydrocarbon radical, and salts thereof, such as vinylphosphonic acid, 2-acrylamido-2-methylpropanephosphonic acid, 2-methacrylamido-2-methylpropanephosphonic acid, 2-acrylamidoethanephosphonic acid, 2-methacrylamidoethanephosphonic acid, 2-acryloyloxyethanephosphonic acid, 2-methacryloyloxyethanephosphonic acid, 3-acryloyloxypropanephosphonic acid and 2-methacryloyloxypropanephosphonic acid, and salts thereof,
monoethylenically unsaturated phosphoric monoesters, more particularly the monoesters of phosphoric acid with hydroxy-C₂-C₄ alkyl acrylates and hydroxy-C₂-C₄ alkyl methacrylates, such as, for example, 2-acryloyloxyethyl phosphate, 2-methacryloyloxyethyl phosphate, 3-acryloyloxypropyl phosphate, 3-methacryloyloxypropyl phosphate, 4-acryloyloxybutyl phosphate and 4-methacryloyloxybutyl phosphate, and salts thereof.

Where the monomers M2 are present in their salt form, they have a corresponding cation as counterion. Examples of suitable cations are alkali metal cations such as Na⁺ or K⁺, alkaline earth metal ions such as the Ca²⁺ and Mg²⁺, and also ammonium ions such as NH₄⁺, tetraalkylammonium cations such as tetramethylammonium, tetraethylammonium, and tetrabutylammonium, and also protonated primary, secondary and tertiary amines, more particularly those which carry 1, 2 or 3 radicals selected from C₁-C₂₀ alkyl groups and hydroxyethyl groups, e.g., the protonated forms of mono-, di-, and tributylamine, propylamine, diisopropylamine, hexylamine, dodecylamine, oleylamine, stearylamine, ethoxylated oleylamine, ethoxylated stearylamine, ethanolamine, diethanolamine, triethanolamine or of N,N-dimethylethanolamine. Preference is given to the alkali metal salts.

Among the monomers M2, the monoethylenically unsaturated sulfonic acids and salts thereof, more particularly their alkali metal salts, are preferred. Among the monomers M2, the vinylaromatic sulfonic acids, more particularly the styrenesulfonic acids, and especially 4-vinylbenzenesulfonic acid, and salts thereof, more particularly their alkali metal salts, are particularly preferred.

Examples of monomers M3 are
ethylenically unsaturated monomers which have at least 2, e.g., 2, 3 or 4 ethylenically unsaturated double bonds and which are preferably nonionic (monomers M3a below),
monoethylenically unsaturated, neutral monomers (monomers M3b below), which have a water solubility of at least 50 g/l at 25° C. and more particularly at least 100 g/l at 25° C.; and
monoethylenically unsaturated C₃-C₈ monocarboxylic and C₄-C₈ dicarboxylic acids (monomers M3c below), for example, acrylic acid, methacrylic acid, crotonic acid, maleic acid, fumaric acid or itaconic acid.

Examples of monomers M3a are as follows:
esters of monohydric, unsaturated alcohols such as allyl alcohol, 1-buten-3-ol, 5-hexen-1-ol, 1-octen-3-ol, 9-decen-1-ol, dicyclopentenyl alcohol, 10-undecen-1-ol, cinnamyl alcohol, citronellol, crotyl alcohol or cis-9-octadecen-1-ol with one of the aforementioned monoethylenically unsaturated C₃-C₈ monocarboxylic acids, more particularly the esters of acrylic acid or of methacrylic acid, especially the allyl esters such as allyl acrylate and allyl methacrylate,
di-, tri-, and tetra-esters of the aforementioned monoethylenically unsaturated C₃-C₈ monocarboxylic acids, more particularly the di-, tri-, and tetra-esters of acrylic acid or of methacrylic acid, with aliphatic or cycloaliphatic diols or polyols, more particularly the diesters of acrylic acid or of methacrylic acid with dihydric alcohols, examples being alkanols, such as 1,2-propanediol, 1,3-propanediol, 1,2-butanediol, 1,3-butanediol, 2,3-butanediol, 1,4-butanediol, but-2-ene-1,4-diol, 1,2-pentanediol, 1,5-pentanediol, 1,2-hexanediol, 1,6-hexanediol, 1,10-decanediol, 1,2-dodecanediol, 1,12-dodecanediol, neopentyl glycol, 3-methylpentane-1,5-diol, 2,5-dimethyl-1,3-hexanediol, 2,2,4-trimethyl-1,3-pentanediol, 1,2-cyclohexanediol, 1,4-cyclohexanediol, 1,4-bis(hydroxymethyl)-cyclohexane, the mono-neopentylglycol ester of hydroxypivalic acid, 2,2-bis(4-hydroxyphenyl)propane, 2,2-bis[4-(2-hydroxypropyl)phenyl]propane, diethylene glycol, triethylene glycol, tetraethylene glycol, dipropylene glycol, tripropylene glycol, tetrapropylene glycol, 3-thiapentane-1,5-diol, polyethylene glycols, polypropylene glycols or polytetrahydrofurans having molecular weights of in each case 200 to 10 000, and also the di-, tri-, and tetra-esters of acrylic acid or of methacrylic acid with polyhydric polyols such as trimethylolpropane, glycerol, pentaerythritol, 1,2,5-pentanetriol, 1,2,6-hexanetriol, cyanuric acid, sorbitans, sucrose, glucose or mannose;
diesters of the aforementioned monohydric, unsaturated alcohols, more particularly of allyl alcohol with dibasic carboxylic acids such as malonic acid, tartaric acid, trimellitic acid, phthalic acid, terephthalic acid, citric acid or succinic acid;
linear, branched or cyclic, aliphatic or aromatic hydrocarbons which possess at least two ethylenically unsaturated double bonds, which in the case of aliphatic hydrocarbons must not be conjugated, e.g., divinylbenzene, divinyltoluene, 1,7-octadiene, 1,9-decadiene, 4-vinyl-1-cyclohexene or trivinylcyclohexane;
acrylamides, methacrylamides, and N-allylamines of at least difunctional amines. Such amines are, for example, 1,2-diaminoethane, 1,3-diaminopropane, 1,4-diaminobutane, 1,6-diaminohexane, 1,12-dodecanediamine, piperazine, diethylenetriamine or isophoronediamine; and
N,N′-divinyl compounds of urea derivatives, at least difunctional amides, cyanurates or urethanes, as for example of urea, ethyleneurea, propyleneurea or tartaramide, e.g., N,N′-divinylethyleneurea or N,N′-divinylpropyleneurea.

Among the monomers M3a, the esters of monohydric, unsaturated alcohols with one of the aforementioned monoethylenically unsaturated C₃-C₈ monocarboxylic acids, more particularly the esters of acrylic acid or of methacrylic acid, especially the allyl esters such as allyl acrylate and allyl methacrylate, and also the diesters of monoethylenically unsaturated C₃-C₈ monocarboxylic acids, more particularly the diesters of acrylic acid or of methacrylic acid, with dihydric alcohols, especially with C₃-C₁₀ alkanediols such as 1,2-propanediol, 1,3-propanediol, 1,2-butanediol, 1,3-butanediol, 2,3-butanediol, 1,4-butanediol, but-2-ene-1,4-diol, 1,2-pentanediol, 1,5-pentanediol, 1,2-hexanediol, 1,6-hexanediol, 1,10-decanediol, or with oligoalkylene glycols such as diethylene glycol, triethylene glycol, tetraethylene glycol, dipropylene glycol, tripropylene glycol or tetrapropylene glycol, are preferred. Among the monomers M3a, the allyl esters of monoethylenically unsaturated C₃-C₈ monocarboxylic acids such as allyl acrylate and allyl methacrylate, and also the diesters of acrylic acid or of methacrylic acid with C₃-C₁₀ alkanediols, such as 1,4-butanediol diacrylate or 1,6-hexanediol diacrylate, and the diesters of acrylic acid or of methacrylic acid with diethylene glycol, triethylene glycol or tetraethylene glycol, are particularly preferred.

The fraction of the monomers M3a as a proportion of the monomers M will in general not exceed 10%, more particularly 5%, and especially 3%, by weight, based on the total amount of the monomers M. In one preferred embodiment of the invention the monomers M comprise 0.1% to 9.9%, more particularly 0.2% to 4.8%, and especially 0.3% to 2.7%, by weight, based on the total amount of the constituent monomers of the polymer P, of one or more monomers M3a, more particularly one or more of the monomers M3a identified as being preferred or particularly preferred.

Examples of monomers M3b are as follows:
the amides of the aforementioned monoethylenically unsaturated C₃-C₈ monocarboxylic acids, more particularly acrylamide and methacrylamide,
hydroxyalkyl esters of the aforementioned monoethylenically unsaturated C₃-C₈ monocarboxylic acids, e.g., hydroxyethyl acrylate, hydroxyethyl methacrylate, 2- and 3-hydroxypropyl acrylate, 2- and 3-hydroxypropyl methacrylate,
monoesters of the aforementioned monoethylenically unsaturated C₃-C₈ monocarboxylic and C₄-C₈-dicarboxylic acids with C₂-C₄ polyalkylene glycols, more particularly the esters of these carboxylic acids with polyethylene glycol or with alkyl-polyethylene glycols, the (alkyl)polyethylene glycol radical typically having a molecular weight in the range from 100 to 3000;
N-vinyl amides of aliphatic C₁-C₁₀ carboxylic acids, and N-vinyl lactams, such as N-vinylformamide, N-vinylacetamide, N-vinylpyrrolidone, and N-vinylcaprolactam.

Preferred monomers M3b are the amides of the aforementioned monoethylenically unsaturated C₃-C₈ monocarboxylic acids, more particularly acrylamide and methacrylamide, and the hydroxyalkyl esters of the aforementioned monoethylenically unsaturated C₃-C₈ monocarboxylic acids, e.g., hydroxyethyl acrylate, hydroxyethyl methacrylate, 2- and 3-hydroxypropyl acrylate, 2- and 3-hydroxypropyl methacrylate.

The fraction of the monomers M3b as a proportion of the monomers M will in general not exceed 10%, more particularly 5%, by weight, based on the total amount of monomers M. In one preferred embodiment of the invention the monomers M comprise none or less than 0.1% by weight, based on the total amount of the constituent monomers of the polymer P, of monomers M3b.

Preferred monomers M3c are acrylic acid and methacrylic acid.

The fraction of the monomers M3c as a proportion of the monomers M will in general not exceed 5%, more particularly 3%, by weight, based on the total amount of monomers M. In one preferred embodiment of the invention the monomers M comprise none or less than 0.1% by weight, based on the total amount of the constituent monomers of the polymer P, of monomers M3c.

In one preferred embodiment of the invention the constituent monomers M of the polymer P comprise:
70% to 99.9%, more particularly 80% to 99.8% or 80% to 99.7%, and especially 90% to 99.7% or 90% to 99.5%, by weight, of at least one monomer M1, selected from the group consisting of esters of monoethylenically unsaturated C₃-C₆ monocarboxylic acids with C₁-C₂₀ alkanols, C₅-C₈-cycloalkanols, phenyl-C₁-C₄ alkanols or phenoxy-C₁-C₄alkanols, the diesters of monoethylenically unsaturated C₄-C₆-dicarboxylic acids with C₁-C₂₀ alkanols, C₅-C₈ cycloalkanols, phenyl-C₁-C₄ alkanols or phenoxy-C₁-C₄ alkanols, vinylaromatic hydrocarbons, the mixtures of these monomers, and the mixtures of one or more of these monomers with acrylonitrile or methacrylonitrile, the fraction of acrylonitrile and methacrylonitrile being preferably not more than 50%, more particularly not more than 30%, and especially not more than 10%, by weight, based on the total amount of the monomers M1;
0.1% to 10%, more particularly 0.2% to 7%, and especially 0.3% to 5%, by weight, of at least one monoethylenically unsaturated monomer M2, more particularly one of the monomers M2 said to be preferred or particularly preferred, and especially styrenesulfonic acid or the salts thereof, the figures in % by weight being based on the free acid; and optionally
0% to 29.9%, frequently 0% to 19.8% or 0.1% to 19.8%, and more particularly 0% to 9.7% or 0.2% to 9.7%, by weight, of one or more monomers M3, which are different from the monomers M1 and M2 and which preferably are selected from the monomers M3a, M3b and M3c, and more particularly from the monomers M3a and mixtures of the monomers M3a with one or more monomers M3b and/or M3c;
   all figures in % by weight being based on the total weight of the constituent monomers M of the polymer.

In one particularly preferred embodiment of the invention the constituent monomers M of the polymer P comprise:
90% to 99.8%, more particularly 90% to 99.6%, and especially 90% to 99.5%, by weight, of at least one monomer M1, selected from the group consisting of the esters of monoethylenically unsaturated C₃-C₆ monocarboxylic acids with C₁-C₂₀ alkanols, C₅-C₈-cycloalkanols, phenyl-C₁-C₄ alkanols or phenoxy-C₁-C₄ alkanols, the diesters of monoethylenically unsaturated C₄-C₆-dicarboxylic acids with C₁-C₂₀ alkanols, C₅-C₈ cycloalkanols, phenyl-C₁-C₄ alkanols or phenoxy-C₁-C₄ alkanols, vinylaromatic hydrocarbons, the mixtures of these monomers, and the mixtures of one or more of these monomers with acrylonitrile or methacrylonitrile, the fraction of acrylonitrile and methacrylonitrile being preferably not more than 50%, more particularly not more than 30%, and especially not more than 10%, by weight, based on the total amount of the monomers M1;
0.1% to 10%, more particularly 0.2% to 7%, and especially 0.3% to 5%, by weight, of at least one monoethylenically unsaturated monomer M2, more particularly one of the monomers M2 said to be preferred or particularly preferred, and especially styrenesulfonic acid or the salts thereof, the figures in % by weight being based on the free acid;
0.1% to 9.9%, more particularly 0.2% to 4.8%, and especially 0.2% to 2.7%, by weight, of one or more monomers M3a;
optionally up to 5%, and more particularly less than 0.1%, by weight of monoethylenically unsaturated monomers selected from the monomers M3b and M3c;
   all figures in % by weight being based on the total weight of the constituent monomers M of the polymer.

In these preferred and particularly preferred embodiments, the monomers M1 are preferably selected from the esters of monoethylenically unsaturated C₃-C₆ monocarboxylic acids, more particularly the esters of acrylic acid or of methacrylic acid, with C₁-C₂₀ alkanols, the vinylaromatic hydrocarbons, especially styrene, and mixtures thereof. More particularly the monomers M1 are selected from the esters of acrylic acid with C₂-C₁₀ alkanols, the esters of methacrylic acid with C₁-C₁₀ alkanols, and vinylaromatic hydrocarbons, especially styrene, and mixtures thereof. With particular preference the monomers M1 are selected from C₁-C₄ alkyl methacrylates, C₂-C₁₀ alkyl acrylates, styrene, mixtures of C₁-C₄ alkyl methacrylates of styrene, mixtures of styrene with C₂-C₁₀ alkyl acrylates, mixtures of C₁-C₄ alkyl methacrylates with C₂-C₁₀ alkyl acrylates, and mixtures of C₁-C₄ alkyl methacrylates with styrene and C₂-C₁₀ alkyl acrylates. In one very particularly preferred embodiment of the invention, the monomers M1 are selected from C₁-C₄alkyl methacrylates, especially methyl methacrylate, mixtures of methyl methacrylate with styrene, mixtures of C₁-C₄ alkyl methacrylates, especially methyl methacrylate, with C₂-C₁₀ alkyl acrylates, and mixtures of C₁-C₄ alkyl methacrylates, especially methyl methacrylate, with styrene and C₂-C₁₀ alkyl acrylates, where the fraction of C₁-C₄ alkyl methacrylates, especially methyl methacrylate, based on the total amount of the monomers M′, is at least 50% by weight.

In these preferred and particularly preferred embodiments the monomers M3a are preferably selected from the monomers M3a specified above as being preferred or particularly preferred.

In these preferred and particularly preferred embodiments the monomers M3b are preferably selected from the monomers M3b specified above as being preferred or particularly preferred.

In these preferred and particularly preferred embodiments the monomers M3c are preferably selected from the monomers M3c specified above as being preferred or particularly preferred.

The polymer P present in the active ingredient compositions of the invention frequently has a glass transition temperature in the range from −60 to 150° C. In this context it has proven advantageous if the polymer P present in the compositions of the invention has a glass transition temperature, T_{g}, of at least 0° C., preferably at least 50° C., more particularly at least 70° C. In particular the glass transition temperature will not exceed a value of 150° C., and more preferably 120° C. Also suitable, however, are active ingredient compositions whose polymer P has a glass transition temperature of below 0° C. Where the active ingredient composition of the invention comprises two or more polymers P having different glass transition temperatures—whether in the form of staged polymers or core-shell polymers, including multiphase polymers with blackberry, raspberry or half-moon morphology, or in the form of blends of different polymers P—the fraction of polymers having a glass transition temperature of at least 0° C., preferably at least 50° C., more particularly at least 70° C., is preferably at least 60% by weight.

By the glass transition temperature T_{g} here is meant the temperature at the inflection point (“midpoint temperature”) determined in accordance with ASTM D 3418-82 by differential scanning calorimetry (DSC) with a scan rate of 10 K/min (cf. Ullmann's Encyclopedia of Industrial Chemistry, 5th edition, volume A 21, VCH Weinheim 1992, p. 169, and also Zosel, Farbe and Lack 82 (1976), pp. 125-134; see also DIN 53765).

Alternatively the glass transition temperature T_{g} may be determined by means of dynamic mechanical analysis (DMA).

In this context it proves useful to estimate the glass transition temperature T_{g} of the copolymer P. According to Fox (T. G. Fox, Bull. Am. Phys. Soc. (Ser. II) 1, 123 [1956] and Ullmanns Enzyklopädie der technischen Chemie, Weinheim (1980), pp. 17-18), the glass transition temperature of copolymers with low degrees of crosslinking is given at high molar masses in good approximation by

$$\frac{1}{{T}_{g}} = \frac{{X}^{1}}{{T}_{g}^{1}} + \frac{{X}^{2}}{{T}_{g}^{2}} + … \frac{{X}^{n}}{{T}_{g}^{n}}$$

where X¹, X², . . . , Xⁿ are the mass fractions of the monomers 1, 2, . . . , n and T_{g}¹, T_{g}², . . . , T_{g}ⁿ are the glass transition temperatures of the polymers composed in each case only of one of the monomers 1, 2, . . . , n, in degrees Kelvin. The latter are known, for example, from Ullmann's Encyclopedia of Industrial Chemistry, VCH, Weinheim, vol. A 21 (1992) p. 169 or from J. Brandrup, E. H. Immergut, Polymer Handbook 3rd ed., J. Wiley, New York 1989.

The active crop protection ingredients (ACPIs) present in the active ingredient compositions of the invention may in principle be selected from any desired organic active ingredients for crop protection that have low water solubility, with a solubility in water at 25° C. and 101.325 hPa (pH 4-9) of not more than 5 g/l, frequently not more than 3 g/l, and more particularly not more than 1 g/l. These include in principle all water-insoluble or low-water-solubility organic active ingredients for crop protection from the group of the fungicides, insecticides, herbicides, nematicides, molluscicides and growth regulators. Organic active ingredients of these kinds may be liquid or solid and they typically have a molecular weight in the range from 100 to 400 daltons. Preference is given to nonionic organic active ingredients and also to active ingredients which, if they contain basic or acidic groups, are present in neutral form. It is of advantage, moreover, if the active ingredient is not volatile under atmospheric pressure, i.e., has a boiling point or evaporation point of more than 180° C.

The advantages of the present invention are manifested more particularly with those organic ACPIs of low water solubility that are difficult to formulate in water, on account, for example, of their low melting point and/or their oily consistency at low temperatures. Accordingly, the advantages of the invention are manifested more particularly with those organic ACPIs of low water solubility whose melting point does not exceed a value of 90° C., more particularly a value of 80° C. or 75° C., or with active ingredients which have no melting point and which at these temperatures have an oily consistency. Where the active ingredient may be present in two or more modifications, which have different melting points, the advantage of the process is also manifested when one of these modifications has a melting point within the stated limits. The advantages of the invention are also manifested for active ingredient mixtures when the melting point of the active ingredient mixture does not exceed a value of 90° C., more particularly a value of 80° C. or 75° C., and with active ingredient mixtures which have no melting point and which at these temperatures have an oily consistency, even when one of the active ingredients has a melting point above the limits indicated here.

One embodiment of the invention, accordingly, relates to those aqueous active ingredient compositions in which the organic ACPI of low water solubility that is present in the polymer particles, or the active ingredient mixture, has a melting point of not more than 90° C., more particularly a value of not more than 80° C. or not more than 75° C., or which have no melting point and at these temperatures have an oily consistency.

Examples of ACPIs which have a melting point below 90° C. are acetamiprid, benalaxyl, benalaxyl-M, cyprodinil, beta-cyfluthrin, gamma-cyhalothrin, alpha-cypermethrin, difenoconazole, fenpropimorph, imazalil, ipconazole, permethrin, prochloraz, pyraclostrobin, silthiofam, tetraconazole, and trifloxystrobin.

Accordingly, one embodiment of the invention relates to those aqueous active ingredient compositions in which the organic ACPI of low water solubility that is present in the polymer particles is selected from acetamiprid, benalaxyl, benalaxyl-M, cyprodinil, beta-cyfluthrin, gamma-cyhalothrin, alpha-cypermethrin, cyprodinil, difenoconazole, fenpropimorph, imazalil, ipconazole, permethrin, prochloraz, pyraclostrobin, silthiofam, tetraconazole, and trifloxystrobin, and mixtures thereof.

In one particularly preferred embodiment of the invention the ACPI in the polymer-active ingredient particles is prochloraz. Prochloraz is a low-melting organic ACPI from the group of the fungicides, and per se cannot be stably formulated as an aqueous suspension concentrate. Hitherto the only possibility for formulating prochloraz stably as an aqueous suspension concentrate has been to convert it into transition metal salt complexes, preferably with copper(II) chloride, by coformulating prochloraz with water-soluble metal salts, preferably copper(II) chloride. For a range of applications, however, the use of transition metal salts is undesirable. Through the invention, therefore, it is possible to circumvent the use of prochloraz in the form of its transition metal salt complexes, particularly its copper(II) chloride complex, and the use of transition metal salts, especially copper salts, for the purpose of preparing stable aqueous suspensions of prochloraz.

For the purpose of stabilizing the polymer-active ingredient particles dispersed therein, the aqueous active ingredient compositions of the invention comprise at least one surface-active substance, which in general is anionic or nonionic. Such substances include anionic and nonionic emulsifiers and also anionic and nonionic protective colloids or stabilizers. By emulsifiers are meant, in contradistinction to protective colloids, surface-active substances whose molecular weight (number average) is typically below 2000 g/mol and especially below 1500 g/mol. Protective colloids, in turn, are usually water-soluble polymers having a number-average molecular weight of above 2000 g/mol, in the range from 2000 to 100 000 g/mol, for example, and in the range from 5000 to 50 000 g/mol in particular. It will be appreciated that protective colloids and emulsifiers can be used in a mixture.

The amount of surface-active substance used in stabilizing the polymer-active ingredient particles is typically in the range from 0.1% to 10%, preferably in the range from 0.2% to 5%, by weight, based on 100% by weight of polymer P, or based on 100% by weight of the constitutent monomers M of the polymer.

In one embodiment of the invention, the aqueous active ingredient compositions of the invention comprise at least one anionic surface-active substance, more particularly at least one anionic emulsifier, and especially at least one anionic emulsifier which has at least one SO₃X group attached via C atom or an O atom, with X being hydrogen or a suitable counterion, such as an alkali metal, alkaline earth metal or ammonium cation, for example. The emulsifiers are in general not polymerizable, i.e., they do not contain ethylenically unsaturated groups which can be polymerized in a free-radical polymerization. Some or all of the emulsifiers, however, may be polymerizable. Such polymerizable emulsifiers comprise ethylenically unsaturated groups and are either nonionic or anionic emulsifiers. Polymerizable nonionic emulsifiers are preferably selected from C₂-C₃ alkoxylates of alkenols, more particularly of prop-2-en-1-ol, and monoesters of monoethylenically unsaturated monocarboxylic or dicarboxylic acids with poly-C₂-C₃-alkylene ethers, the degree of alkoxylation being 3 to 100 in each case. Polymerizable anionic emulsifiers are preferably selected from the corresponding sulfuric and phosphoric monoesters of the abovementioned nonionic polymerizable emulsifiers.

The nonpolymerizable anionic emulsifiers typically include aliphatic carboxylic acids having in general at least 10 C atoms, e.g., 10 to 20 C atoms, and also their salts, more particularly their ammonium salts and alkali metal salts; aliphatic, araliphatic, and aromatic sulfonic acids having in general at least 6 C atoms, e.g., 6 to 30 C atoms, and also their salts, more particularly their ammonium salts and alkali metal salts; sulfuric monoesters of ethoxylated alkanols and alkylphenols, and also their salts, more particularly their ammonium salts and alkali metal salts; and also alkyl, aralkyl and aryl phosphates, including phosphoric monoesters of alkanols and alkylphenols.

Examples of anionic emulsifiers preferred in accordance with the invention are the salts, more particularly the alkali metal salts and ammonium salts, of
dialkyl esters of sulfosuccinic acid (alkyl radicals: each C₄ to C₁₂) such as dibutyl sulfosuccinate, dihexyl sulfosuccinate, dioctyl sulfosuccinate, di(2-ethylhexyl) sulfosuccinate or didecyl sulfosuccinate,
alkyl sulfates (alkyl radical: C₈ to C₁₈) such as lauryl sulfate, isotridecyl sulfate or cetyl sulfate, stearyl sulfate;
sulfuric monoesters of ethoxylated alkanols (EO degree: 2 to 30, alkyl radical: C₁₀ to C₁₈), such as the sulfates of (poly)ethoxylated lauryl alcohol, of (poly)ethoxylated isotridecanol, of (poly)ethoxylated myristyl alcohol, of (poly)ethoxylated cetyl alcohol, of (poly)ethoxylated stearyl alcohol,
sulfuric monoesters of ethoxylated alkylphenols (EO degree: 2 to 30, alkyl radical: C₄ to C₁₈),
alkyl sulfonic acids (alkyl radical: C₈ to C₁₈) such as laurylsulfonate and isotridecylsulfonate,
mono-, di-, and trialkylarylsulfonic acids (alkyl radical: C₄ to C₁₈) such as dibutylnaphthylsulfonate, cumylsulfonate, octylbenzenesulfonate, nonylbenzenesulfonate, dodecylbenzenesulfonate, and tridecylbenzenesulfonate,
sulfuric monoesters of di- or tristyrylphenol ethoxylates (EO degree: 2 to 30);
monoesters and diesters of phosphoric acid, including their mixtures with the corresponding triesters, more particularly their esters with C₈-C₂₂ alkanols, (poly)ethoxylated C₈-C₂₂ alkanols, C₄-C₂₂ alkylphenols, (poly)ethoxylated C₄-C₂₂ alkylphenols, or (poly)ethoxylated di- or tristyrylphenols.

Examples of suitable anionic emulsifiers are also the compounds, indicated below, of the general formula A

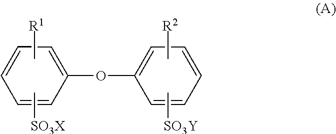

in which R¹ and R² are hydrogen or C₄-C₁₄ alkyl and are not simultaneously hydrogen, and X and Y are suitable cations, examples being alkali metal ions and/or ammonium ions. Preferably R¹ and R² are hydrogen or linear or branched alkyl radicals having 6 to 18 C atoms, and more particularly having 6, 12 or 16 C atoms, and R¹ and R² are not both simultaneously hydrogen. X and Y are preferably sodium, potassium or ammonium ions, with sodium being particularly preferred. Particularly advantageous compounds are those in which X and Y are sodium, R¹ is a branched alkyl radical having 12 C atoms, and R² is hydrogen or has one of the non-hydrogen definitions indicated for R¹. Use is frequently made of technical mixtures which have a fraction of 50% to 90% by weight of the monoalkylated product, an example being Dowfax®2A1 (trademark of the Dow Chemical Company).

Suitable nonionic emulsifiers are, commonly, ethoxylated alkanols having 8 to 36 C atoms, more particularly 10 to 22 C atoms, in the alkyl radical, and ethoxylated mono-, di-, and trialkylphenols having, commonly, 4 to 12 C atoms in the alkyl radicals, the ethoxylated alkanols and alkylphenols commonly having a degree of ethoxylation in the range from 3 to 50.

Other suitable emulsifiers are found in, for example, Houben-Weyl, Methoden der organischen Chemie, volume 14/1, Makromolekulare Stoffe, Georg Thieme Verlag, Stuttgart, 1961, pp. 192 to 208.

In one preferred embodiment of the invention the at least one surface-active substance selected from at least one anionic emulsifier, in particular from at least one of the anionic emulsifiers mentioned above and from combinations of at least one anionic emulsifier with one or more other surface-active substances different from the anionic emulsifiers, more particularly from combination of different anionic emulsfiers and from combinations of at least one anionic emulsifier with at least one non-ionic emulsifier.

In one particularly preferred embodiment of the invention the at least one surface-active substance comprises at least one compound of the formula A, preferably in combination with one or more other surface-active substances different from the compound A, more particularly in combination with one or more other anionic emulsifiers different from the compound A, and especially in combination with a salt of a dialkyl ester of sulfosuccinic acid (alkyl radicals: each C₄ to C₁₂).

In one particularly preferred embodiment of the invention the at least one surface-active substance selected from at least one compound of the formula A and from combinations of at least one compound of the formula A with one or more other surface-active substances different from the compound A, more particularly from combinations with one or more other anionic emulsifiers different from the compound A, and especially from combinations with a salt of a dialkyl ester of sulfosuccinic acid (alkyl radicals: each C₄ to C₁₂).

Besides the aforementioned surface-active substances, the aqueous active ingredient compositions of the invention may also comprise other surface-active substances which are typically used in aqueous crop protection formulations and which serve to modify the performance profile of the aqueous active ingredient composition without necessarily stabilizing the polymer-active ingredient particles, or which serve to stabilize active ingredient particles if the aqueous active ingredient composition of the invention comprises one or more other ACPIs in suspended form.

Such other surface-active substances are likewise preferably selected from nonionic and anionic emulsifiers and protective colloids.

The other anionic surface-active substances include, in addition to the aforementioned anionic surface-active substances, the following in particular:
polymeric anionic surface-active substances having at least one SO₃— or PO₃²— group, examples being condensates or arylsulfonic acids such as naphthalenesulfonic and phenolsulfonic acid with formaldehyde and optionally with urea, ligninsulfonic acids, lignin sulfite waste liquor or ligninsulfonates and salts thereof;
nonpolymeric anionic surface-active substances having at least one carboxylate group, examples being fatty acid such as stearates, and also N-C₆-C₂₂ acylglutamates and N-C₆-C₂₂ acylsarcosides and salts thereof,
polymeric anionic surface-active substances having at least one carboxylate group and salts thereof, e.g.,
   anionic graft copolymers or comb copolymers which have carboxylate groups and polyethylene oxide groups attached to a polymer backbone, more particularly copolymers constructed of (i) monoethylenically unsaturated C₃-C₆ monocarboxylic or C₄-C₈ dicarboxylic acids such as acrylic acid, methacrylic acid or maleic acid, (ii) at least one monoethylenically unsaturated monomer having an oligoethylene or polyethylene oxide group which is attached via an ether or ester group to an ethylenically unsaturated radical, more particularly an ester of an oligoethylene or polyethylene oxide with a monoethylenically unsaturated C₃-C₆ monocarboxylic acid such as acrylic acid or methacrylic acid, and optionally (iii) one or more hydrophobic monomers having a water solubility of not more than 60 g/l at 25° C. and 101.325 hPa, an example being a comb polymer constructed of methacrylic acid, methyl methacrylate, and an ester of a polyethylene oxide monomethyl ether with methacrylic acid, e.g., the copolymer with the CAS No. 1000934-04-1, available commercially as Tersperse® 2500, or the copolymer having the CAS No. 119724-54-8, available commercially as Atlox® 4913;
   anionic copolymers which are constructed of (i) monoethylenically unsaturated C₃-C₈ monocarboxylic or C₄-C₈ dicarboxylic acids, and (ii) hydrophobic monomers having a water solubility of not more than 60 g/l at 25° C. and 101.325 hPa, and which are selected more particularly from olefins and styrene, examples being maleic anhydride/olefin copolymers.

The other nonionic surface-active substances include, in addition to the aforementioned nonionic surface-active substances, the following in particular:
nonionic emulsifiers such as fatty amine alkoxylates, polyoxyethylene glycerol fatty acid esters, castor oil alkoxylates, fatty acid alkoxylates, fatty acid amide alkoxylates, fatty acid polydiethanolamides, lanolin ethoxylates, fatty acid polyglycol esters, isotridecyl alcohol, fatty acid amides, alkylpolyglycosides, and glycerol fatty acid esters;
nonionic protective colloids such as polyethylene glycol, polypropylene glycol, polyethylene glycol-polypropylene glycol block copolymers, polyethylene glycol alkyl ethers, polypropylene glycol alkyl ethers, polyethylene glycol-polypropylene glycol ether block copolymers, and mixtures thereof.

The total amount of surface-active substance is typically in the range from 0.1% to 20%, preferably in the range from 0.2% to 10%, by weight, based on the total weight of the aqueous active ingredient composition.

The advantages of the present invention are manifested especially in those active ingredient compositions of the invention which are to be formulated with a thickener or which comprise a thickener. Thickeners are substances which increase the viscosity of the aqueous active ingredient composition in comparison to an aqueous active ingredient composition comprising no such thickener. Examples of thickeners known to increase the viscosity of aqueous dispersions are polysaccharides, synthetic, water-soluble polymers such as polyacrylic acids with a low degree of crosslinking (INCI name: Carbomer), poly(2-acrylamidomethylpropanesulfonic acid), and also highly disperse silica and phyllosilicates, especially natural or modified clay minerals such as, for example, sodium lithium magnesium silicates, montmorillonites, attapulgites, and the like, optionally with organic modification.

The present invention accordingly relates in particular to an aqueous active ingredient composition which comprises at least one thickener, more particularly at least one thickener selected from polysaccharide thickeners.

The advantages of the present invention are manifested in particular with those thickeners that are selected from polysaccharide thickeners. These include modified celluloses and modified starches, especially cellulose ethers such as methylcellulose, carboxymethylcellulose, hydroxyethylcellulose, hydroxypropylcellulose, methylhydroxypropylcellulose, methylhydroxyethylcellulose, natural polysaccharides such as xanthan, carrageenan, especially κ-carrageenan, λ-carrageenan or ι-carrageenan, alginates, guaran, and agar, and also modified xanthan such as succinylglycan or modified carrageenan. Preference is given to polysaccharide thickeners, more particularly those having anionic groups such as carboxymethylcellulose, xanthan, modified xanthan, carrageenan, modified carrageenan, and alginates, and especially xanthan and modified xanthan, examples being the xanthan products sold under the commercial names Kelzan® from Kelco and Rhodopol®, e.g., the Rhodopol® products 23, 50MC, G, T, and TG, from Rhodia.

The amount of thickener may be varied over wide ranges and is dependent in a manner known per se on the desired viscosity and on the nature of the thickener. The amount of thickener needed in order to obtain the desired viscosity can be determined by the skilled worker in routine experiments. The concentration of thickener in the aqueous active ingredient composition is typically in the range from 0.01% to 1% by weight, based on the total weight of the aqueous active ingredient composition.

As already mentioned in the introduction, the aqueous active ingredient compositions of the invention are especially suitable for coformulation with ACPIs that can be formulated in water. The aqueous active ingredient compositions of the invention are suitable more particularly for incorporation into aqueous formulations of ACPIs. This produces aqueous active ingredient compositions which as well as the active ingredient or ingredients present in the polymer particles comprise one or more other ACPIs different from the active ingredient or ingredients present in the polymer particles. Accordingly, one preferred embodiment of the invention relates to aqueous active ingredient compositions as described above which further comprise at least one other organic ACPI. This other ACPI may, if sufficiently soluble, be in solution in the aqueous phase of the active ingredient composition or, if of low water solubility, in suspended form, i.e., in the form of suspended particles.

Where present, the active ingredient compositions of the invention comprise the at least one other ACPI commonly in an amount of 0.5% to 55%, more particularly in an amount of 1% to 50%, by weight, based on the total weight of the formulation.

Suitable other ACPIs which may be present in the active ingredient compositions of the invention in addition to the ACPIs in the polymer particles are in principle all crop-protection-suitable organic or inorganic active ingredients which are known to be aqueously formulable. They may be selected, for example, from the group of the fungicides, insecticides, herbicides, nematicides, molluscicides, and growth regulators. The other active ingredients are preferably organic ACPIs which may be liquid or solid and which typically have a molecular weight in the range from 100 to 400 daltons. It is of advantage if the other ACPI is not volatile under atmospheric pressure, i.e., has a boiling point or evaporation point of more than 180° C.

Examples of suitable other active ingredients are the aforementioned ACPIs and additionally:

fungicides from the groups of the
azoles, especially those from the group of
   triazole fungicides such as, for example, azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole or uniconazole;
   imidazole fungicides such as, for example, cyazofamid, imazalil, imazalil sulfate, pefurazoate, or triflumizole;
   benzimidazoles such as, for example, benomyl, carbendazim, fuberidazole or thiabendazole;
strobilurins, such as, for example, azoxystrobin, dimoxystrobin, coumoxystrobin, coumethoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, methyl 2-[2-(2,5-dimethylphenyloxy-methyl)phenyl]-3-methoxy acrylate or 2-(2-(3-(2,6-dichlorophenyl)-1-methyl-allylideneaminooxymethyl)phenyl)-2-methoxyimino-N-methylacetamide;
carboxamides, especially from the groups of
   carboxanilides, such as, for example, benalaxyl, benalaxyl-M, benodanil, bixafen, boscalid, carboxin, fenfuram, fenhexamid, flutolanil, fluxapyroxad, furametpyr, isopyrazam, isotianil, kiralaxyl, mepronil, metalaxyl, ofurace, oxadixyl, oxycarboxin, penflufen, penthiopyrad, sedaxane, tecloftalam, thifluzamide, tiadinil, 2-amino-4-methylthiazole-5-carboxanilide, N-(4′-trifluoromethylthiobiphenyl-2-yl)-3-difluoromethyl-1-methyl-1H-pyrazole-4-carboxamide or N-(2-(1,3,3-trimethylbutyl)phenyl)-1,3-dimethyl-5-fluoro-1H-pyrazole-4-carboxamide;
   carboxylic morpholides, such as, for example, dimethomorph, flumorph, and pyrimorph;
   benzoamides, such as, for example, flumetover, fluopicolide, fluopyram or zoxamid;
   other carboxamides, such as, for example, carpropamid, diclocymet, mandipropamid, oxytetracycline, silthiofam or N-(6-methoxypyridin-3-yl)-cyclopropanecarboxamide;
pyridines, such as, for example, fluazinam, pyrifenox, 3-[5-(4-chlorophenyl)-2,3-dimethylisoxazolidin-3-yl]-pyridine or 3-[5-(4-methylphenyl)-2,3-dimethyl-isoxazolidin-3-yl]-pyridine;
pyrimidines, such as, for example, bupirimat, cyprodinil, diflumetorim, fenarimol, ferimzone, mepanipyrim, nitrapyrine, nuarimol or pyrimethanil;
triazolopyrimidienes such as, for example, ametoctradin;
piperazines, such as, for example, triforine;
pyrrols, such as, for example, fludioxonil or fenpiclonil;
morpholines, such as, for example, aldimorph, dodemorph, dodemorph acetate, fenpropimorph or tridemorph;
piperidines, such as, for example, fenpropidin;
thio- and dithiocarbamates, such as, for example, ferbam, mancozeb, maneb, metam, methasulphocarb, metiram, propineb, thiram, zineb or ziram; and
thiophanate-methyl.

Insecticides from the groups of
nicotine receptor agonists/antagonists (CNIs), such as, for example, bensultap, cartap, clothianidin, dinotefuran, imidacloprid, thiamethoxam, nitenpyram, acetamiprid, thiacloprid, thiocyclam, thiosultap-sodium, spinosad, spinetoram or 1-(2-chlorothiazol-5-ylmethyl)-2-nitrimino-3,5-dimethyl-[1,3,5]triazinane;
pyrethroids such as, for example, allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin or dimefluthrin;
phenylpyrazole insecticides such as, for example, endosulfane, ethiprol, fipronil, vaniliprol, pyrafluprol, pyriprol or 5-amino-1-(2,6-dichloro-4-methylphenyl)-4-sulfinamoyl-1H-pyrazole-3-thiocarboxamide; and
anthranilamides such as chlorantraniliprole, cyantraniliprole or rynaxypyr.

In one preferred embodiment the other ACPI has a low water solubility, preferably a solubility in water at 25° C. and 101.325 hPa of not more than 5 g/l, more particularly not more than 3 g/l, and especially not more than 1 g/l. In the aqueous active ingredient composition, such active ingredients are present in suspended form, i.e., in the form of suspended particles. The average particle diameter of the suspended particles of the other ACPI is typically in the range from 800 nm to 50 μm, more particularly in the range from 1 to 20 μm, and especially in the range from 1.2 to 10 μm, with preferably less than 10% by weight of the particles of the other active ingredient having a particle size above 50 μm, and more particularly less than 10% by weight of the particles of the other active ingredient having a particle size of more than 20 μm.

In one preferred embodiment the other ACPI has a melting point of at least 50° C., more particularly at least 70° C., and more particularly at least 80° C.

Examples of preferred other active ingredients are as follows: pyraclostrobin, fluxapyroxad, boscalid, dimethomorph, metalaxyl, triticonazole, metconazole, fluquinconazole, pyrimethanil, thiophanate-methyl, fipronil, alpha-cypermethrin, rynaxypyr, thiametoxam, clothianidin, and imidacloprid.

Preferred active ingredient combinations are indicated in the table below:

| | Active ingredient in | |
|---|---|---|
| No. | polymer particles | Other active ingredient(s) |
| 1 | Prochloraz | Triticonazole |
| 2 | Prochloraz | Pyraclostrobin |
| 3 | Prochloraz | Pyraclostrobin + triticonazole |
| 4 | Prochloraz | Pyrimethanil + triticonazole |

The above-stated active ingredient combinations may further comprise one or more ACPIs which are present in suspension, emulsion or solution in the aqueous phase of the active ingredient composition of the invention.

Furthermore, the active ingredient composition of the invention of course comprises an aqueous phase in which the polymer-active ingredient particles are in suspension or dispersion and, optionally, one or more other active ingredients are in suspension or dispersion, emulsion or solution.

The amount of polymer-active ingredient particles in the aqueous phase is commonly in the range from 10% to 60% by weight, based on the total weight of the active ingredient composition. Where the active ingredient composition of the invention comprises one or more other active ingredients of low water solubility, in the form of suspended active ingredient particles, the total amounts of polymer-active ingredient particles and the at least one other active ingredient will not exceed 60% by weight, based on the total weight of the aqueous active ingredient composition.

The aqueous phase comprises the surface-active substance and the optionally present thickener in dissolved form and may further comprise typical additives in dissolved or suspended or emulsified form. Examples of such additives, besides the aforementioned surface-active substances which serve to stabilize the polymer-active ingredient particles, are surface-active substances for stabilizing optionally suspended active ingredients, adjuvants, antifoams, preservatives (bactericides), adhesives or stickers or adhesion agents, antifreeze agents, colorants, and agents for adjusting the pH.

Surface-active substances for stabilizing the ACPI and/or the optionally other ACPIs are the surface-active substances typically used in aqueous crop protection formulations, said substances being as already recited above.

Examples of suitable antifoams include silicone emulsions (such as, for example, Silikon® SRE, Wacker or Rhodorsil®, from Rhodia), long-chain alcohols and mixtures thereof, fatty acids, fatty acid esters of polyglycerols, organofluorine compounds, and mixtures thereof. Antifoams are used typically in amounts of 0.01 to 5 grams per liter of the active ingredient composition of the invention.

Preservatives may be added in order to stabilize the active ingredient compositions of the invention against infestation with microorganisms. Examples of suitable preservatives include alkyl esters of para-hydroxybenzoic acid, sodium benzoate, 2-bromo-2-nitropropane-1,3-diol, ortho-phenylphenol, dichlorophen, benzyl alcohol hemiformal, pentachlorophenol, 2,4-dichlorobenzyl alcohol, and also, in particular, substituted isothiazolones such as, for example, C₁-C₁₀-alkylisothiazolinones, 5-chloro-2-methyl-4-isothiazolinone, and benzoisothiazolinones, examples being the products sold under the name Proxel® from Avecia (or from Arch) or Acticide® from Thor Chemie. Preservatives are used typically in amounts of 0.01 to 10 grams per liter of the active ingredient composition of the invention.

Suitable antifreeze agents are organic polyols, e.g., ethylene glycol, propylene glycol or glycerol. They are used typically in amounts of not more than 10% by weight, based on the total weight of the active ingredient composition.

Suitable colorants are the pigments and dyes that are typically used in crop protection formulations, such as, for example, Pigment blue 15:4, Pigment blue 15:3, Pigment blue 15:2, Pigment blue 15:1, Pigment blue 80, Pigment yellow 1, Pigment yellow 13, Pigment red 112, Pigment red 48:2, Pigment red 48:1, Pigment red 57:1, Pigment red 53:1, Pigment orange 43, Pigment orange 34, Pigment orange 5, Pigment green 36, Pigment green 7, Pigment white 6, Pigment brown 25, Basic violet 10, Basic violet 49, Acid red 51, Acid red 52, Acid red 14, Acid blue 9, Acid yellow 23, Basic red 10, Basic red 108.

Examples of adhesives or stickers and adhesion agents are ethylene oxide and/or propylene oxide block polymer surfactants and also polyvinyl alcohols, polyvinyl acetates, partially hydrolyzed polyvinyl acetates, polyvinylpyrrolidones, polyacrylates, polymethacrylates, polybutenes, polyisobutenes, polystyrenes, polyethyleneamines, polyethyleneamides, polyethyleneimines (Lupasol®, Polymin®), polyethers, and copolymers derived from the aforementioned polymers.

The active ingredient compositions of the invention may optionally comprise 1% to 5% by weight, based on the total amount of the prepared formulation, of agents for pH regulation, examples being buffers, the amount and nature of the buffer used being guided by the chemical properties of the active ingredient or ingredients. Examples of agents for adjusting the pH are alkali metal salts of weak inorganic or organic acids such as, for example, phosphoric acid, boric acid, acetic acid, propionic acid, citric acid, fumaric acid, tartaric acid, oxalic acid, and succinic acid.

The aqueous active ingredient composition of the invention can be prepared by a free-radical aqueous emulsion polymerization of a solution of the at least one ACPI in the constituent ethylenically unsaturated monomers M of the polymer P, as defined above, in an aqueous polymerization medium in the presence of at least one surface-active substance, where the emulsion polymerization is preferably performed as a monomer feed process in an aqueous polymerization medium in the presence of at least one surface-active substance and of at least one seed polymer which is dispersed in the polymerization medium and has an average particle size, determined by dynamic light scattering, in the range from 50 to 300 nm, more particularly 60 to 250 nm, and very preferably in the range 70 to 200 nm.

In accordance with the invention, the preparation of the aqueous active ingredient composition comprises a free-radical aqueous emulsion polymerization of a solution of the at least one ACPI in the constituent ethylenically unsaturated monomers M of the polymer P in the presence of at least one surface-active substance.

In accordance with the invention the free-radical aqueous emulsion polymerization takes place in the presence of at least one surface-active substance.

Surface-active substances contemplated are the emulsifiers and protective colloids used typically for emulsion polymerization, as have already been stated above as constituents of the active ingredient composition of the invention. The amounts of surface-active substances typically used for an emulsion polymerization are typically in the ranges indicated above, and so the total amount or a part of the surface-active substances present in the compositions of the invention is supplied via the emulsion polymerization. It is, however, also possible to use only a part, e.g., 10% to 90%, more particularly 20% to 80%, by weight, of the surface-active substances present in the composition of the invention in the emulsion polymerization, and to add the remainder of surface-active substance following the emulsion polymerization, before or after a deodorization—to be carried out optionally—of the emulsion polymerization (aftersoaping).

The surface-active substance used for the polymerization preferably comprises, in particular, at least one anionic surface-active substance, more particularly at least one anionic emulsifier, and especially at least one anionic emulsifier which has at least one SO₃X group attached via a C atom or an O atom, X being hydrogen or a suitable counterion, such as an alkali metal, alkaline earth metal or ammonium cation, for example. The surface-active substance used for the polymerization optionally comprises, further to the anionic surface-active substance, one or more nonionic surface-active substances, more particularly one or more nonionic emulsifiers. The surface-active substances used in the polymerization are preferably nonpolymerizable, i.e., they have no ethylenically unsaturated groups which are polymerizable in a free-radical polymerization. Suitable surface-active substances for the emulsion polymerization are, in particular, the surface-active substances recited before in connection with the stabilization of the polymer-active ingredient particles, especially the anionic and nonionic emulsifiers recited there.

Examples of anionic emulsifiers preferred in accordance with the invention for the emulsion polymerization of the monomers M are the salts, more particularly the alkali metal salts and ammonium salts, of the above-recited
dialkyl esters of sulfosuccinic acid (alkyl radicals: each C₄ to C₁₂),
alkyl sulfates (alkyl radical: C₈ to C₁₈);
sulfuric monoesters of ethoxylated alkanols (EO degree: 2 to 30, alkyl radical: C₁₀ to C₁₈);
sulfuric monoesters of ethoxylated alkylphenols (EO degree: 2 to 30, alkyl radical: C₄ to C₁₈):
alkyl sulfonic acids (alkyl radical: C₈ to C₁₈);
mono-, di-, and tri-alkylarylsulfonic acids (alkyl radical: C₄ to C₁₈);
sulfuric monoesters of di- or tristyrylphenol ethoxylates (EO degree: 2 to 30);
monoesters and diesters of phosphoric acid, including mixtures thereof with the corresponding triesters; and
compounds of the above-defined general formula A.

Examples of anionic emulsifiers preferred in accordance with the invention for the emulsion polymerization of the monomers M are ethoxylated alkanols having 8 to 36 C atoms, more particularly 10 to 22 C atoms, in the alkyl radical, and ethoxylated mono-, di-, and tri-alkylphenols having commonly 4 to 12 C atoms in the alkyl radicals, the ethoxylated alkanols and alkylphenols commonly having a degree of ethoxylation in the range from 3 to 50.

In one particularly preferred embodiment of the invention, the polymerization of the monomers M takes place in the presence of at least one compound of the formula A, preferably in the presence of a combination thereof with one or more other surface-active substances, different from the compound A, more particularly in the presence of a combination thereof with one or more other anionic emulsifiers which are different from the compound A, and especially in the presence of a combination thereof with a salt of a dialkyl ester of sulfosuccinic acid (alkyl radicals: each C₄ to C₁₂).

The amount of surface-active substance used in the emulsion polymerization is commonly in the range from 0.1% to 10%, more particularly in the range from 0.2% to 5%, by weight, based on the total amount of the monomers M to be polymerized.

Preferably, the polymerization takes place in the presence of a seed polymer which is dispersed in the polymerization medium and has an average particle size, determined by dynamic light scattering, in the range from 50 to 300 nm, more particularly 60 to 250 nm, and very preferably in the range 70 to 200 nm. By a seed polymer is meant a finely divided polymer, free of active ingredient, which is present in dispersion in the aqueous polymerization medium in the form of finely divided particles, and which commonly is used in the form of an aqueous dispersion in the emulsion polymerization of the monomers M. Aqueous dispersions of this kind are therefore also called seed latex.

The amount of seed polymer used in the emulsion polymerization is in general in the range from 0.01% to 5%, and more particularly in the range from 0.05% to 1%, by weight, based on the total amount of the monomers M, calculated as polymer constituent of the seed latex. The concentration of seed polymer in the seed latex is commonly in the range from 10% to 60% by weight.

The seed polymer is constructed in general of polymerized, ethylenically unsaturated monomers M, which in general comprise at least 90%, e.g., 90% to 100%, frequently 90% to 99.9%, more particularly 95% to 99.8%, and especially 97% to 99.7%, by weight, of one or more monoethylenically unsaturated monomers M′, as defined above, and optionally up to 10%, e.g., 0.1% to 10%, more particularly 0.2% to 5%, and especially 0.3% to 3%, by weight, of one or more different monomers, the amounts in % by weight being based on the total amount of the constituent monomers of the seed polymer.

The monoethylenically unsaturated monomers M′ for preparing the seed polymer are preferably selected from the aforementioned:
esters of monoethylenically unsaturated C₃-C₆ monocarboxylic acids with C₁-C₂₀ alkanols, C₅-C₈ cycloalkanols, phenyl-C₁-C₄ alkanols or phenoxy-C₁-C₄alkanols, more particularly the aforementioned esters of acrylic acid and also the aforementioned esters of methacrylic acid, more particularly the esters of monoethylenically unsaturated C₃-C₆ monocarboxylic acids, more particularly the ester of acrylic acid or of methacrylic acid, with C₁-C₂₀ alkanols, and
vinylaromatic hydrocarbons, such as, for example, styrene, vinyltoluenes, tert-butylstyrene, α-methylstyrene, and the like, especially styrene;
   and mixtures thereof.

In one particularly preferred embodiment of the invention, the monomers M′ incorporated by copolymerization in the seed polymer are selected from C₁-C₄ alkyl methacrylates, C₂-C₁₀ alkyl acrylates, styrene, mixtures of C₁-C₄ alkyl methacrylates with styrene, mixtures of styrene with C₂-C₁₀ alkyl acrylates, mixtures of C₁-C₄ alkyl methacrylates with C₂-C₁₀ alkyl acrylates, and mixtures of C₁-C₄ alkyl methacrylates with styrene and C₂-C₁₀ alkyl acrylates.

In one very particularly preferred embodiment of the invention the monomers M′ are selected from C₁-C₄ alkyl methacrylates, especially methyl methacrylate, mixtures of methyl methacrylate with styrene, mixtures of C₁-C₄ alkyl methacrylates, especially methyl methacrylate, with C₂-C₁₀ alkyl acrylates, and mixtures of C₁-C₄ alkyl methacrylates, especially methyl methacrylate, with styrene and C₂-C₁₀ alkyl acrylates, with the fraction of C₁-C₄ alkyl methacrylates, especially methyl methacrylate, based on the total amount of the monomers M′, being at least 50% by weight.

In addition, the seed latex in general further comprises one or more of the monomers M3a, as defined above, in copolymerized form. Among the monomers M3a copolymerized in the seed polymer, the esters of monohydric, unsaturated alcohols with one of the aforementioned monoethylenically unsaturated C₃-C₈ monocarboxylic acids, more particularly the esters of acrylic acid or of methacrylic acid, especially the allyl esters such as allyl acrylate and allyl methacrylate, and also the diesters of monoethylenically unsaturated C₃-C₈ monocarboxylic acids, more particularly the diesters of acrylic acid or of methacrylic acid with dihydric alcohols, more particularly the diesters of acrylic acid or of methacrylic acid with C₃-C₁₀ alkanediols, such as 1,4-butanediol diacrylate or 1,6-hexanediol diacrylate, and the diesters of acrylic acid or of methacrylic acid with diethylene glycol, triethylene glycol or tetraethylene glycol, are particularly preferred.

The fraction of the monomers M3a as a proportion of the constituent monomers of the seed polymer will in general not exceed 10%, more particularly 5%, and especially 3%, by weight, based on the total amount of the constituent monomers of the seed polymer. In one preferred embodiment of the invention the constitutent monomers of the seed polymer comprise 0.1% to 9.9%, more particularly 0.2% to 4.8%, and especially 0.3% to 2.7%, by weight, of one or more monomers M3a, more particularly one or more of the monomers M3a identified as being preferred or particularly preferred.

In addition, the seed polymer may also comprise, in copolymerized form, one or more further monomers, examples being monomers M3b or M3c, the fraction of such monomers not exceeding in general 10%, more particularly 5%, and especially 3%, by weight, based on the total amount of the constituent monomers of the seed polymer.

The seed polymer commonly has a glass transition temperature in the range from −60 to 150° C. In this context it has proven advantageous if the seed polymer has a glass transition temperature T_{g} of at least 50° C., preferably at least 60° C., more particularly at least 70° C.

Preferably, the polymerization takes place through a free-radical aqueous emulsion polymerization of a solution of the at least one ACPI in the monomers M to be polymerized, in accordance with what is known as a monomer feed process.

In this process, an oil-in-water emulsion of the monomers M to be polymerized, in an aqueous polymerization medium, is subjected to free-radical polymerization conditions. The oil-in-water emulsion of the active ingredient/monomer solution can be produced in situ by adding a solution of the active ingredient in the monomers M to be polymerized to the polymerization vessel which is under polymerization conditions. Preferably, however, the active ingredient will be dissolved in the monomers M and the resulting monomer solution will be converted into an aqueous monomer emulsion before the resulting monomer/active ingredient emulsion is supplied to the polymerization reaction.

By a monomer feed process is meant a polymerization process in which the major amount, preferably at least 70% and more particularly at least 90%, of the solution of the active ingredient in the monomers M, or the major amount, preferably at least 70% and more particularly at least 90%, of an aqueous emulsion of monomer, active ingredient, and preferably at least one portion of the surface-active substance used in the polymerization, is supplied to the polymerization vessel in the course of the polymerization reaction. The addition of the monomer/active ingredient solution or emulsion takes place preferably over a period of at least 0.5 h, more particularly at least 1 h, e.g., 1 to 12 h, and more particularly 2 to 6 h. The monomer/active ingredient solution or emulsion may be added at a constant or varying rate—for example, in intervals with a constant rate of addition or with a varying rate of addition, or continuously with a varying rate of addition. The composition of the monomer/active ingredient solution or emulsion may remain constant or be changed during the addition, in which case changes may be made in respect not only of the monomer composition but also of the surface-active substance, the nature of the active ingredient, or the concentration of the active ingredient in the monomers M.

In general the procedure here will be such that the major amount or total amount of the seed polymer, generally at least 80% by weight and more particularly at least 90% by weight, will be introduced in the form of an aqueous polymer dispersion (seed latex) as an initial charge to the polymerization vessel, and the major amount or total amount of the monomers M, and also the major amount of total amount of the at least one ACPI, will be supplied to the polymerization vessel, under the polymerization conditions necessary for a free-radical emulsion polymerization, over a certain period of in general at least 0.5 h, more particularly at least 1 h, e.g., 1 to 12 h, and more particularly 2 to 6 h. As already mentioned above, the active ingredient will be supplied together with a portion or the total amount of the monomers M as a solution of the active ingredient in the monomers M. This solution of the active ingredient in the monomers M is preferably emulsified in water prior to the polymerization, with the aid of at least one of the aforementioned surface-active substances, and this emulsion is then supplied to the polymerization under polymerization conditions.

The emulsion polymerization is typically initiated by addition of at least one initiator, i.e., of a compound which, on exposure to heat or light, forms free radicals which trigger the actual polymerization. The initiators that are suitable for the emulsion polymerization of the invention are the polymerization initiators which are suitable and used typically for an emulsion polymerization, and which trigger free-radical polymerization of the monomers M. These initiators include azo compounds such as 2,2′-azobisisobutyro-nitrile, 2,2′-azobis(2-methylbutyronitrile), 2,2′-azobis[2-methyl-N-(-2-hydroxyethyl)propionamide], 1,1′-azobis(1-cyclohexanecarbonitrile), 2,2′-azobis(2,4-dimethylvaleronitrile), 2,2′-azobis(N,N′-dimethyleneisobutyroamidine) dihydrochloride, and 2,2′-azobis(2-amidinopropane) dihydrochloride, organic or inorganic peroxides such as diacetyl peroxide, di-tert-butyl peroxide, diamyl peroxide, dioctanoyl peroxide, didecanoyl peroxide, dilauroyl peroxide, dibenzoyl peroxide, bis(o-tolyl) peroxide, succinyl peroxide, tert-butyl peracetate, tert-butyl permaleinate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butyl peroxy-2-ethylhexanoate, and diisopropyl peroxidicarbamate, salts of peroxodisulfuric acid such as sodium peroxodisulfate, and redox initiator systems.

It is preferred to use water-soluble initiators, examples being salts of peroxodisulfuric acid, more particularly sodium, potassium or ammonium salts, or a redox initiator system comprising as oxidizing agent a salt of peroxodisulfuric acid, hydrogen peroxide or an organic peroxide such as tert-butyl hydroperoxide. As reducing agents they preferably comprise a sulfur compound which more particularly is selected from sodium hydrogen sulfite, sodium hydroxymethanesulfinate, and the adduct of hydrogen sulfite with acetone. Other suitable reducing agents are phosphorus-containing compounds such as phosphorous acid, hypophosphites, and phosphinates, and also hydrazine or hydrazine hydrate, and ascorbic acid. Redox initiator systems may further comprise an addition of small amounts of redox metal salts such as iron salts, vanadium salts, copper salts, chromium salts or manganese salts, such as the ascorbic acid/iron(II) sulfate sodium peroxodisulfate redox initiator system, for example.

The initiator is used typically in an amount of 0.02% to 2%, and more particularly 0.05% to 1.5%, by weight, based on the amount of monomers M. The optimum amount of initiator is of course dependent on the initiator system used and can be determined by the skilled worker in routine experiments. The initiator may be included partly or wholly in the initial charge to the reaction vessel. It is preferred to add the major amount of the initiator, more particularly at least 80%, e.g., 80% to 99.5% of the initiator, to the polymerization reactor in the course of the polymerization.

In one preferred embodiment of the invention the monomer composition is altered in the course of the monomer addition such that the rate at which the at least one monomer M2 is supplied to the polymerization medium goes up or increases in the course of the addition. The increase in the rate of addition of the monomers M2 is in general such that the rate of addition toward the end of the addition, i.e., when at least 80% of the total amount of the monomers M2 is already in the polymerization vessel, is at least twice, more particularly at least five times, as high as at the beginning of the addition of the monomers M2. The rate of addition in this case, at the beginning of the addition of the monomers M2, is in general in the range from 0.1%/h to 10%/h, and toward the end of the addition is in the range from 5%/h to 20%/h, the % figures indicating the fraction of the monomers M2 added in the respective time interval at the beginning and toward the end of the addition, respectively, based on the total amount of the monomers M2 supplied. In the course of the addition, the rate of addition may be raised in steps or continuously, and, in the course of the addition, the raise being able to be constant or to be lesser or, in particular, greater toward the end of the addition.

In one preferred embodiment of the invention, in the course of the addition of monomer, the rate at which the at least one surface-active substance is supplied to the polymerization medium is altered in such a way that it rises or increases in the course of the addition. The increase in the rate of addition is in general such that the rate of addition toward the end of the addition, i.e., when at least 80% of the total amount of the monomers M2 is already in the polymerization vessel, is at least twice, more particularly at least three times, as high as at the beginning of the addition of the at least one surface-active substance. The rate of addition in this case, at the beginning of the addition of the surface-active substance, is in general in the range from 0.05%/h to 10%/h, and toward the end of the addition is in the range from 2%/h to 20%/h, the % figures indicating the fraction of the surface-active substance added in the respective time interval at the beginning and toward the end of the addition, respectively, based on the total amount of the surface-active substance. In the course of the addition, the rate of addition may be raised in steps or continuously, and, in the course of the addition, the raise being able to be constant or to be lesser or, in particular, greater toward the end of the addition.

The rate of addition of the monomers M, which are different from the monomers M2, preferably remains constant or changes only slightly, i.e., by less than 30%, based on the average rate of addition of the monomers M different from the monomers M2.

Pressure and temperature are of minor importance for the emulsion polymerization. The temperature is of course dependent on the initiator system used, and an optimum polymerization temperature may be determined by the skilled worker by means of routine experiments. Typically the polymerization temperature is in the range from 20 to 110° C., frequently in the range from 50 to 95° C. The polymerization is typically carried out under atmospheric pressure or ambient pressure. It may alternatively be carried out at elevated pressure, e.g., up to 3 bar, or under slightly reduced pressure, e.g., >800 mbar.

It will be appreciated that the molecular weight of the polymers can be adjusted by addition of regulators in a small amount, e.g., 0.01% to 2% by weight, based on the monomers M to be polymerized. Regulators contemplated include, in particular, organic thio compounds, and also allyl alcohols and aldehydes.

Following the emulsion polymerization reaction proper it is optionally necessary largely to free the aqueous active ingredient compositions of the invention from odorous substances, such as residual monomers and other volatile organic constituents. This may be achieved, in a manner known per se, physically, by distillative removal (in particular via steam distillation) or by stripping with an inert gas. The lowering in residual monomers may also take place chemically, by free-radical postpolymerization, more particularly with the action of redox initiator systems, of the kind recited, for example, in DE-A 44 35 423, in DE-A 44 19 518, and in DE-A 44 35 422. The postpolymerization is preferably carried out with a redox initiator system comprising at least one organic peroxide and an organic sulfite.

After the end of the polymerization, the resulting polymer dispersions, comprising active ingredient, may be adjusted to the desired pH by addition of acids or bases, prior to their inventive use.

Obtained in this way are stable, aqueous active ingredient compositions in the form of aqueous polymer/active ingredient dispersions comprising at least one ACPI in the polymer particles of the dispersion. In addition, the resulting dispersions comprise the abovementioned surface-active substances used in the emulsion polymerization of the invention.

The solids content of the aqueous polymer/active ingredient dispersions obtainable by the free-radical emulsion polymerization of the invention is determined in first approximation by the active ingredient and by the polymer P, and is in general in the range from 10% to 60% by weight and more particularly in the range from 20% to 50% by weight.

The aqueous polymer/active ingredient dispersions thus obtained are notable for a high stability and low volatile organic compounds content, these compounds typically accounting for not more than 1% by weight, frequently not more than 0.1% by weight, and more particularly not more than 500 ppm, based on the total weight of the composition. Volatile compounds, here and below, are all organic compounds which under atmospheric pressure have a boiling point of below 200° C.

Moreover, the aqueous polymer/active ingredient dispersions obtainable in this way can be formulated, like aqueous suspension concentrates, with the additives typical for this purpose, especially thickeners, without separation occurring. More particularly the aqueous polymer/active ingredient dispersions thus obtainable can be coformulated with aqueous formulations, especially aqueous suspension concentrates, of ACPIs which comprise the additives typical for the purpose, especially thickeners, without separation occurring.

The invention accordingly also relates to a process in which an aqueous polymer/active ingredient dispersion obtainable by the free-radical aqueous emulsion polymerization of the invention is formulated with at least one additive which is typical for crop protection compositions.

The invention accordingly also relates to a process in which an aqueous polymer/active ingredient dispersion obtainable by the free-radical aqueous emulsion polymerization of the invention is coformulated with at least one ACPI which is suitable for aqueous crop protection compositions.

The invention further relates, accordingly, to a process in which an aqueous polymer/active ingredient dispersion obtainable by the free-radical aqueous emulsion polymerization of the invention is formulated with a thickener.

The invention, accordingly, relates in particular to a process in which an aqueous polymer/active ingredient dispersion obtainable by the free-radical aqueous emulsion polymerization of the invention is incorporated into a conventional suspension concentrate of an organic ACPI.

The incorporation of the thickeners, additives, and other active ingredients may be accomplished in a conventional way, as for example by incorporations of aqueous solutions, aqueous emulsions or aqueous dispersions of the additives/active ingredients, by means, for example, of the mixing of the aqueous solutions, emulsions or dispersions with the polymer/active ingredient dispersion.

The aqueous active ingredient compositions of the invention are suitable in a manner known per se for controlling phytopathogenic organisms, where the nature of the phytopathogenic organism or organisms that can be controlled with the aqueous active ingredient compositions of the invention is guided in a manner known per se by the active ingredient or ingredients present in the polymer/active ingredient dispersion or by the active ingredient or ingredients present in the aqueous active ingredient compositions of the invention.

Where the active ingredient compositions of the invention comprise at least one ACPI with fungicidal action (i.e., fungicide), they are suitable in a known way for controlling phytopathogenic—i.e., plant-damaging—fungi.

Where the active ingredient compositions of the invention comprise at least one ACPI with insecticidal or acaricidal action (i.e., insecticide or acaricide), they are suitable in a known way for controlling unwanted insect or mite infestation.

Where the active ingredient compositions of the invention comprise at least one ACPI with herbicidal action (i.e., herbicide), they are suitable in a known way for controlling unwanted plant growth.

The present invention accordingly further provides:
use of the aqueous active ingredient compositions of the invention for controlling phytopathogenic organisms; and
methods for controlling phytopathogenic organisms, comprising the contacting of the harmful organisms, their habitat, their hosts, such as plants and seed, and also the soil, the area and the surroundings in which they are or might be growing, and also of materials, plants, seed, soil, surfaces or spaces that are to be protected from attack or infestation by or with phytopathogenic organisms, with an effective amount of the formulations of the invention.

A further aspect of the invention relates to the use of the aqueous active ingredient compositions of the invention for protecting plants, including seed, especially crop plants, from infestation by harmful organisms. The present invention accordingly also relates to the use of the formulations for controlling phytopathogenic organisms such as, for example, harmful fungi, insects, arachnids, nematodes, and weeds. According to one preferred embodiment, the invention relates to the use of the formulations for protecting seed from infestation by harmful fungi, insects, arachnids, and nematodes, especially from infestation by harmful fungi.

The aqueous active ingredient compositions of the invention may be applied neat or diluted with water. According to one preferred embodiment, the formulations are employed neat. In another preferred embodiment, the formulations, prior to application, are diluted with up to 10 parts of water, preferably with up to 50 parts of water, and more particularly with up to 20 parts of water, per part of the active ingredient composition, with all parts denoting parts by weight.

The dilution is customarily brought about by pouring the aqueous active ingredient compositions of the invention into water. For rapid mixing of the aqueous active ingredient compositions of the invention with water it is usual to use agitation, such as stirring, for example. However, agitation is in general not necessary. Although the temperature for the dilution procedure is not a critical factor, dilutions are generally carried out at temperatures in the range from 0° C. to 50° C., more particularly at 10° C. to 30° C. or at ambient temperature.

In general, the water used for dilution is mains water. However, the water may already include water-soluble compounds which are used in crop protection, such as nutrients, fertilizers or pesticides, for instance.

The optionally diluted aqueous active ingredient compositions of the invention are used or applied using methods and apparatus that are known to the skilled person. In particular, their use for seed treatment may be carried out in accordance with customary techniques for treating seed, as for example by seed dressing, seed coating, seed soaking, seed film coating, seed multilayer coating, seed encrusting, seed dripping, and seed pelleting.

According to a first embodiment of the seed treatment, the seed, i.e., those parts of the plant that are capable of propagation and are intended for sowing, is treated with an aqueous active ingredient composition of the invention or with an aqueous dilution thereof. The term “seed” here encompasses seeds and all kinds of plant parts that are capable of propagation, including seeds, seed grains, seed parts, saplings, fruits, tubers, cereal grains, cuttings or the like, especially grains and seeds.

The seed may be treated, for example, by mixing, spraying or misting the seed with an aqueous active ingredient composition of the invention or with a dressing liquor obtained from it by dilution with water, prior to sowing and prior to the emergence of the plants. These measures can be carried out in specific apparatus for the treatment of seed, such as in dressing machines, for example. Treatment, however, may also be accomplished simply by mixing an aqueous active ingredient composition of the invention with the seed in a vessel, as for example in a bag, a bucket or a trough, and then allowing the seed to dry.

The seed may alternatively also be treated during sowing with an aqueous active ingredient composition of the invention.

In a further embodiment of the seed or soil treatment of the invention, the aqueous active ingredient composition of the invention will be placed into furrows which already contain the seed. An alternative option is first to treat the furrow with an aqueous active ingredient composition of the invention, and then to introduce the seed into the furrow.

In a further embodiment of the invention, plants that have already grown are treated with the formulations, in particular by spraying. For this purpose, the aqueous active ingredient compositions of the invention may be applied neat or in the form of an aqueous dilution to the plants.

Generally speaking, the manner in which an aqueous active ingredient composition of the invention is employed ought to be guided by the particular end use; in any case, the extremely fine distribution of the ACPIs present in the formulation ought to be ensured.

The amounts of aqueous active ingredient composition of the invention that are used for seed treatment are in general selected such that the seed comes into contact with an effective amount of the ACPIs present in the formulation. Generally speaking, for 100 kg of seed, the amount of an active ingredient composition of the invention that will be used comprises 0.1 g to 10 kg, more particularly 1 g to 5 kg, and especially from 1 g to 2.5 kg, of the active plant ingredient or of a mixture of such active ingredients. For certain crop plants, such as lettuce and onions, for instance, the amounts of active ingredient to be used may be greater.

Depending on the nature of the active ingredient used, the active ingredient compositions of the invention are suitable for treating the seed of any desired crop plants, examples being cereal plants, root plants, oil plants, vegetables, spices, ornamentals, and the like, in the treatment, for example, of seed of the following plants: durum wheat and other wheat species, oats, rye, barley, maize, including fodder maize and sweet corn, millet, soybean, brassica, cotton, sunflower, bananas, rice, oilseed rape, beet, sugar beet, fodder beet, egg plant, potatoes, turf, grass seed, tomatoes, leek, pumpkin, cabbage, salad plants, peppers, cucumbers, melons, beans, peas, garlic, onions, carrots, tobacco, grapes, petunias, geraniums, pelargoniums, pansies, and the like.

The active ingredient compositions of the invention are also suitable for treating the seed of crop plants which are resistant to herbicides, fungicides, insecticides or nematicides as a consequence of techniques based on cultivation, mutation and/or genetic engineering. For example, formulations can be used to treat seed of transgenic plants which are resistant toward herbicides from the group consisting of sulfonylureas (EP A 0 257 993, U.S. Pat. No. 5,013,659), imidazolinones (cf., e.g., U.S. Pat. No 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073), glufosinates and related compounds (cf., e.g., EP-A-0 242 236, EP-A-242 246), and also glyphosates and related compounds (cf., e.g., WO 92/00377), or for treating seed of plants which are resistant toward herbicides selected from the group of cyclohexadienon/aryloxyphenoxypropionoic acid herbicides (U.S. Pat. No. 5,162,602, 5,290,696, 5,498,544, 5,428,001, 6,069,298, 6,268,550, 6,146,867, 6,222,099, 6,414,222), or for treating seed of transgenic crop plants, such as cotton and maize, for example, which possess the capacity to produce the toxins of Bacillus thuringiensis (Bt toxins) which impart resistances towards certain pests (EP A 0 142 924, EPA 0 193 259).

Furthermore, the active ingredient compositions of the invention may be used to treat the seed of plants which possess modified properties in relation to existing plants and which can be produced, for example, by means of traditional cultivation methods and/or mutations or by recombinant techniques. For instance, there are a multiplicity of descriptions of the production of recombinant variants of crop plants whose purpose is to modify the starch of these plants (e.g., WO 92/11376, WO 92/14827, WO 91/19806) or to change the fatty acid composition of the plants (WO 91/13972).

The seed treated in accordance with the invention is notable for advantageous properties by comparison with conventionally treated seed, and is therefore likewise provided by the present specification.

The examples which follow are intended to illustrate the invention.

### A Abbreviations Used

PMMA: Polymethyl methacrylate
MMA: Methyl methacrylate
AMA: Allyl methacrylate
NaPS: Sodium peroxodisulfate
DI water: Deionized water
t-BHP: tert-Butyl hydroperoxide
PETIA: Pentaerythritol triacrylate

### B Materials:

Emulsifier 1: Aqueous solution of the sodium salt of mono-C₁₂ alkyldiphenyl ether disulfonate, 45% strength by weight (Dowfax® 2A1)
Emulsifier 2: Sodium salt of the dioctyl ester of sulfosuccinic acid (Lumiten I RA)
Emulsifier 3: Ammonium salt of the sulfuric monoester of ethoxylated tristyrylphenol (16 EO—Soprophor 4D384 from Rhodia)
Protective colloid 1: Copolymer of methacrylic acid, MMA, and methylpolyethyleneoxy acrylate (Tersperse 2500 from Huntsman or Atlox 4913 from Croda)
Seed dispersion 1: 44% by weight PMMA latex of 99% by weight MMA and 1% by weight AMA, particle diameter (light scattering) 90 nm.
Seed dispersion 2: 33% by weight polystyrene latex particle diameter (light scattering) 30 nm
Defoamer: Silicone emulsion: Wacker Silicone SRE-PFL
Pigment paste: 30% by weight dispersion of Pigment red 48: 2 in water (Microsol Red C2B Agro from BASF SE)
Microbiocide: Methylisothiazolinone/benzoisothiazolinone mixture: Acticide® MBS, Thor GmbH, Speyer
   Suspension concentrate 1: (Triticonazole Formulation)

For preparing the suspension concentrate 1 1371.2 g of triticonazole (purity 91.2%), 50 g of emulsifier 3, 175 g of protective colloid 1, 150 g of glycerol, 5 g of defoamer and 750 g of water were mixed in a glass beaker. The mixture was homogenized by stirring, then ground first with a rotor-stator mill and then with a bead mill to a particle size D90<4 μm (laser diffraction). 2161 g of the resulting suspension were admixed, with thorough stirring, with 6.5 g of defoamer, 3.5 g of microbiocide, 86.4 g of a 2% strength aqueous solution of xanthan gum, and 226.6 g of water, to form the finished product.

Suspension concentrate 2: (Pyraclostrobin Formulation)

For preparing suspension concentrate 2 122.2 kg of pyraclostrobin (purity 90%), 3.3 kg of emulsifier 3, 8.8 kg of protective colloid 1, 13.2 kg of glycerol, 0.44 kg of defoamer and 79.2 kg of water were mixed in a stirring vessel. The mixture was homogenized by stirring, then ground first with a rotor-stator mill and then with a bead mill to a particle size D90<4 μm (laser diffraction). 219.7 kg of the resulting suspension were admixed, with thorough stirring, with 0.64 kg of defoamer, 0.43 kg of microbiocide, 23.4 kg of a 2% strength aqueous solution of xanthan gum, and 4.1 kg of water, to form the finished product.

### C Analysis

The particle diameter was determined by HPPS (High Performance Particle Sizer) with the aid of photon correlation spectroscopy (PCS), also known as quasi-elastic light scattering (QELS) or dynamic light scattering. The measurement method is described in the ISO13321 standard. In this case, a highly diluted aqueous polymer dispersion (c˜0.005%) was analyzed. Measurement configuration: HPPS from Malvern, automated with continuous flow cuvette and Gilson autosampler. Parameters: measurement temperature 22.0° C.; measurement time 120 seconds (6 cycles each of 20 s); scatter angle 173°; laser wavelength 633 nm (HeNe); refractive index of medium 1.332 (aqueous); viscosity 0.9546 mPas. The measurement yields an average value of the cumulant analysis (mean of fits). The mean of fits is an average, intensity-weighted particle diameter in nm.

### D Preparation Examples

Preparation Example 1 (inventive polymer/active ingredient dispersion D1 with 13.6% by weight prochloraz)

A reaction vessel with stirrer was charged with 225 g of deionized water and 3.34 g of seed dispersion 1, and this initial charge was flushed with nitrogen and heated to 80° C. Added with stirring and with the temperature maintained was 25% by weight of feed 2. After 5 minutes, beginning simultaneously, the addition of feed 1 and feed 3 was commenced, and the addition of the remainder of feed 2. Feed 1 and feed 2 were added at a constant flow rate over the course of 180 minutes, with the temperature maintained. Feed 3 was likewise added over the course of 180 minutes. The metered addition of feed 3, however, was carried out not at a constant rate (flow rate=volume per unit time) but instead with a variable flow rate (gradient mode). The flow rate of feed 3 was increased a number of times as the polymerization time progressed; the feed rates at each moment of increase are reported in table 1. After the end of the addition of feeds 1 to 3, the reaction mixture was stirred at 80° C. for 30 minutes more and then was cooled to room temperature.

Feed 1: 275.14 g DI water
4.00 g emulsifier 1 (45% by weight)
436.50 g MMA
4.50 g AMA
180.00 g Prochloraz
   Feed 2: 19.29 g 7% strength by weight solution of NaPS in water
   Feed 3: 112.50 g DI water
9.00 g emulsifier 2
9.00 g styrene-4-sulfonic acid (Na salt)

TABLE 1
Metering rate of feed 3:

| | Time |
|---|---|
| Metering rate [g/h] | [min] |
| 2.7 | 22 |
| 6.4 | 22 |
| 10.1 | 22 |
| 13.8 | 22 |
| 17.5 | 22 |
| 21.1 | 22 |
| 24.9 | 22 |
| 34.1 | 26 |

The dispersion obtained had a solids content of 50% by weight and a prochloraz content of 13.6% by weight (determined by HPLC—work-up in 9:1 acetonitrile:water before application to the HPLC) based on the dispersion. The average particle diameter, determined by light scattering, was 431 nm. The pH was 6.5.

Preparation example 2 (aqueous polymer dispersion CD2 with 7% by weight active ingredient, not inventive)

A reaction vessel with stirrer was charged with 210 g of deionized water, 75 g of maltodextrin and 45.5 g of seed dispersion 2, and this initial charge was flushed with nitrogen and heated to 80° C. Added with stirring and with the temperature maintained was 25% by weight of feed 2. Thereafter, beginning simultaneously, the addition of feed 1 and of the remainder of feed 2 was commenced. Feed 1 and feed 2 were added over the course of 210 minutes, with the temperature maintained. After the end of the addition of feed 1 and feed 2, the temperature was maintained for 30 minutes, and then feed 3 and feed 4 were added over the course of 60 minutes. After the end of feed 3 and feed 4, the apparatus was cooled to room temperature.

Feed 1: 800 g water
12 g emulsifier 1
300 g MMA
80 g Prochloraz
   Feed 2: 45 g 7% strength by weight solution of NaPS in water
   Feed 3: 7 g 10% strength by weight solution of t-BHP in water
   Feed 4: 5 g 10% strength by weight solution of Rongalit C in water

The dispersion obtained had a solids content of 30% by weight and a prochloraz content of 5.6% by weight (determined by means of HPLC (for work-up, see above)). The average particle diameter, determined by light scattering, was 110 nm.

### D Formulation Examples

Comparative Example 1 (aqueous active ingredient composition, not inventive)

Preparation took place by mixing of the constituents indicated in the tables and thorough stirring of the mixture at 22° C. for 1 h in order to swell the xanthan gum homogeneously.

| Constituent | g |
|---|---|
| Dispersion CD2 | 848.1 |
| Suspension concentrate 1 | 32.1 |
| Emulsifier 3 | 26.6 |
| Protective colloid 1 | 25.3 |
| Glycerol | 65.9 |
| Xanthan gum | 2.0 |
| Defoamer | 4.0 |

Example 1 (aqueous active ingredient composition, inventive)

Except for xanthan gum and dispersion D1, all of the constituents indicated in the table below were combined with stirring. Subsequently, with stirring, 2.8 g of xanthan gum were added (in the form of 140 g of a 2% strength aqueous solution).

| Constituent | g |
|---|---|
| Suspension concentrate 1 | 30.9 |
| Suspension concentrate 2 | 23.3 |
| Pigment paste | 150 |
| Emulsifier 3 | 9.0 |
| Protective colloid 1 | 27.3 |
| Glycerol | 91.2 |
| Defoamer | 4.3 |
| Microbiocide | 1.6 |
| Water | 199.0 |
| Dispersion D1 | 321.0 |
| Xanthan Gum | 2.8 |

### E Storage Stability of the Formulations

Samples of the active ingredient compositions described in D were stored for 2 weeks at elevated temperature (50° C.) and also for 2 weeks at fluctuating temperature (12 h at −5° C. and +30° C. or −10° C. and +10° C., each in alternation). In the course of this storage, in the case of the noninventive, comparative example 1, a very pasty liquid phase was formed.

| | | | Appearance after 2 |
|---|---|---|---|
| | Appearance | Appearance after 2 | weeks at −5/+30° C. |
| | immediately | weeks at 50° C. | (12/12 h) |
| Comparative | Homogeneously | 41% pastelike liquid | 44% pastelike liquid |
| example 1 | white | phase | phase |
| | | | Appearance after 2 |
| | Appearance | Appearance after 2 | weeks at −10/+10° C. |
| | immediately | weeks at 54° C. | (12/12 h) |
| Example 1 | Homogeneously | 29% clear liquid | 3% clear liquid phase |
| | red | phase* | |

*Liquid phase formulation due to red pigment paste

1-23. (canceled)

24. An aqueous active ingredient composition in the form of an aqueous dispersion of finely divided polymer-active ingredient particles which comprise at least one water-insoluble polymer P, at least one surface-active substance, and at least one organic active crop protection ingredient which is present in the polymer particles and has a solubility in water of not more than 5 g/l at 25° C. and 101.325 hPa,
wherein the polymer-active ingredient particles have an average particle diameter, determined by dynamic light scattering, in the range from 300 to 1200 nm, and
wherein the polymer P is a polymer of ethylenically unsaturated monomers M which comprise 0.1% to 10% by weight, based on the total amount of the constituent monomers M of the polymer P, of at least one monoethylenically unsaturated compound M2 which is selected from monoethylenically unsaturated sulfonic acids, monoethylenically unsaturated phosphonic acids, and monoethylenically unsaturated phosphoric monoesters, and also the salts thereof.

25. The aqueous active ingredient composition according to claim 24, in which the at least one monoethylenically unsaturated monomer M2 is selected from the group consisting of vinylaromatic sulfonic acids and salts thereof and where the monomers M comprise
70% to 99.9% by weight, based on the total amount of the monomers M, of at least one monomer M1, selected from the group consisting of esters of monoethylenically unsaturated C₃-C₆ monocarboxylic acids with C₁-C₂₀ alkanols, C₅-C₈ cycloalkanols, phenyl-C₁-C₄ alkanols or phenoxy-C₁-C₄alkanols, the diesters of monoethylenically unsaturated C₄-C₆ dicarboxylic acids with C₁-C₂₀ alkanols, C₅-C₈ cycloalkanols, phenyl-C₁-C₄alkanols or phenoxy-C₁-C₄-alkanols, vinylaromatic hydrocarbons, the mixtures of these monomers, and the mixtures of one or more of these monomers with acrylonitrile or methacrylonitrile,
0.1% to 10% by weight, based on the total amount of monomers M, of at least one monomer M2,
0% to 29.9% by weight, based on the total amount of monomers M, optionally of one or more ethylenically unsaturated monomers M3, which are different from the monomers M1 and M2.

26. The aqueous active ingredient composition according to claim 25, wherein the monomers M1 is selected from the group consisting of C₁-C₁₀ alkyl acrylates, C₁-C₁₀ alkyl methacrylates, styrene, and mixtures thereof.

27. The aqueous active ingredient composition according to claim 24, the constituent monomers M of the polymer further comprising 0.1% to 9.9% by weight, based on the total amount of the monomers M, of at least one monomer M3a which contains at least two ethylenically unsaturated double bonds.

28. The aqueous active ingredient composition according to claim 24, the polymer having a glass transition temperature, determined by means of dynamic scanning calorimetry (DSC) in accordance with ASTM-D 2418/82, of at least 0° C.

29. The aqueous active ingredient composition according to claim 24, the fraction of polymer-active ingredient particles having a particle diameter of up to 200 nm, determined by light scattering, being less than 10% by weight, based on the total amount of the polymer-active ingredient particles in the active ingredient composition.

30. The aqueous active ingredient composition according to claim 24, in which the at least one organic active crop protection ingredient has a melting point of not more than 90° C.

31. The aqueous active ingredient composition according to claim 30, in which the at least one organic active crop protection ingredient is selected from the group consisting of acetamiprid, benalaxyl, benalaxyl-M, cyprodinil, beta-cyfluthrin, gamma-cyhalothrin, alpha-cypermethrin, difenoconazole, fenpropimorph, imazalil, ipconazole, permethrin, prochloraz, pyraclostrobin, silthiofam, tetraconazole, and trifloxystrobin.

32. The aqueous active ingredient composition according to claim 24, in which the surface-active substance comprises at least one anionic surface-active substance.

33. The aqueous active ingredient composition according to claim 24, comprising the at least one active crop protection ingredient in an amount of 1% to 50% by weight, based on the total weight of the polymer-active ingredient particles and the polymer P in an amount of 50% to 99% by weight, based on the total weight of the polymer-active ingredient particles.

34. The aqueous active ingredient composition according to claim 24, comprising the polymer-active ingredient particles in a concentration of 10% to 60% by weight, based on the total weight of the active ingredient composition.

35. The aqueous active ingredient composition according to claim 24, further comprising at least one thickener selected from anionic polysaccharides.

36. The aqueous active ingredient composition according to claim 24, further comprising at least one further organic active crop protection ingredient in the form of suspended particles of the active crop protection ingredient.

37. A process for preparing an aqueous active ingredient composition according to claim 24, comprising a free-radical aqueous emulsion polymerization of a solution of the at least one active crop protection ingredient in the constituent ethylenically unsaturated monomers M of the polymer P in accordance with a monomer feed process in an aqueous polymerization medium in the presence of at least one surface-active substance and of at least one seed polymer which is dispersed in the polymerization medium and has an average particle diameter, determined by dynamic light scattering, in the range from 50 to 300 nm.

38. The process according to claim 37, wherein at least a portion of the at least one surface-active substance is supplied to the polymerization medium in the course of the polymerization.

39. The process according to claim 37, wherein the at least one monomer M2 is supplied to the polymerization medium with an increasing feed rate in the course of the polymerization.

40. A method for controlling phytopathogenic fungi and/or unwanted plant growth and/or unwanted insect or mite infestation and/or for regulating the growth of plants, the composition according to claim 24 is allowed to act on the respective pests, their habitat, or the plants to be protected from the respective pest, the soil, and/or on unwanted plants and/or the crop plants and/or their habitat.

41. A method for treating seed, which comprises treating untreated seed with an aqueous active ingredient composition according to claim 24.
